(19) United States
(12) Patent Application Publication
(10) Pub. No.: US 2017/0100215 A1
(43) Pub. Date: Apr. 13, 2017

(54) ORTHODONTIC ASSEMBLY

(71) Applicant: John H. Khouri, Gainesville, VA (US)

(72) Inventor: John H. Khouri, Gainesville, VA (US)

(21) Appl. No.: 14/879,555

(22) Filed: Oct. 9, 2015

(51) Int. Cl. A61C 7/08; A61C 7/36; B23K 31/02; A61C 7/30; B29C 67/00; B22F 3/105; A61C 8/00; A61C 7/10

(52) U.S. Cl. CPC A61C 7/08; A61C 8/0096; A61C 7/36; A61C 7/10; A61C 7/30; B29C 67/0055; B22F 3/1055; B23K 31/02; B33Y 80/00

(57) ABSTRACT

The orthodontic assembly is used in a user's mouth to facilitate tooth movement. The orthodontic assembly includes an interchangeable clip member configured to be removably affixed to a frame member such that the clip member engages at least one of the user's teeth. The orthodontic assembly further includes a frame member configured to be removably positioned proximate the lingual portion of user's teeth. The frame member includes a fastening mechanism configured to cooperatively engage the clip member such that the clip member may be removably affixed to the frame member.

### TECHNICAL FIELD

The invention generally relates to a novel orthodontic assembly. More particularly, the invention relates to an orthodontic assembly having a versatile configuration including interchangeable and flexible components for causing tooth movement, bite correction and/or tooth position retention, while providing enhanced user comfort.

### BACKGROUND OF THE INVENTION

Conventional orthodontic treatments are generally comprised of either fixed or removable components. Typically, the fixed components are bonded or cemented directly to the user's teeth, and a wire is inserted into brackets of the components and secured using elastomeric ties. The wire is usually bendable and may be distorted during the installation and adjustment process by the installer, which is typically an orthodontist or dental practitioner.

As the wire is adjusted into its original shape, the wire exerts a force on the connected tooth or teeth leading to teeth movement. In general, the force applied on teeth with the fixed orthodontic treatment is exerted only by the limited contact of the bracket, which in turn limits the contact forces exerted between the wire and the tooth. As such, in order to properly align the teeth using the fixed orthodontic treatment process, a series of wires are inserted into the brackets connected to the teeth.

The wire insertion process is typically initiated by inserting the most flexible wire first, and then inserting additional wires, gradually increasing the rigidity of the wire inserted into the brackets, thereby moving the teeth into the selected alignment.

One disadvantage of the above-described method is that the single rooted teeth, or the teeth with shorter roots, have a propensity to move first and flare forward, prior to the time of insertion of the more rigid wires, which tend to act on the posterior teeth to expand the arch (as in the cases of crowding). Further, when the wire is inserted into the arch, all of the teeth move simultaneously. As a result, treatment of a single tooth or a limited number of teeth is difficult to achieve without inadvertently exerting unwanted forces on teeth that are not targeted for treatment. Moreover, it is difficult to apply specific and different level forces on different teeth at the same time.

Additional problems with a fixed component orthodontic system may be compounded by poor patient oral hygiene and the inherent difficulties of brushing and flossing teeth with a fixed orthodontic system applied to the tooth. Poor oral hygiene may lead to white spots (decalcifications) appearing around the brackets or degeneration of periodontal tissue surrounding and supporting the teeth Consequently, inflamed gingiva, recession, or irreversible bone loss can occur during orthodontic treatment.

Furthermore, many patients do not like wearing the fixed orthodontic system because of the associated difficulties of chewing and eating and/or because of the undesirable aesthetics.

Removable orthodontic systems used to align the teeth are generally traditional spring acrylic retainers or clear shells that cover the entire surfaces of the teeth, similar to Invisalign®.

The acrylic spring retainers are generally composed of an acrylic frame and wires bent into a predetermined configuration and inserted permanently into the frame at the time of fabrication, where one or more wire components can be adjusted to apply a force on the tooth for tooth movement

The disadvantages of the acrylic spring retainers include, but are not limited to, the following: The fabrication process is prolonged and difficult, especially as related to the fabrication and incorporation of smaller parts into the frame assembly. The size and thickness of the spring retainer can result in discomfort for the user and impede the user's speech. For practitioners, the acrylic spring retainers are of limited utility because they are generally limited to use on a small number of anterior teeth and they have limited capability to align the teeth.

Clear shell aligners are also removable appliances used to align the teeth that are of uniform thickness, cover the entire surface of the teeth, and must be changed with each subsequent movement of teeth.

The disadvantages of the clear shell aligners include, but are not limited to, the following: The user may experience discomfort because the aligners cover the entire surface of the teeth and the aligners may discolor with use, resulting in an unpleasant appearance. The uniformity of the clear shell aligners precludes application of deferential and precise force on specific teeth. For example, because of this, it is difficult to accomplish expansion of the arch successfully.

### SUMMARY

In light of the present need for an orthodontic assembly to facilitate tooth movement and/or bite correction, a brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

The orthodontic assembly to be used in a user's mouth, includes a frame member configured to be removably positioned proximate the lingual portion of the user's teeth including a fastening mechanism, and an interchangeable clip member configured to be removably affixed to the frame member such that the clip member engages at least one of the user's teeth. The fastening mechanism is configured to cooperatively engage the clip member such that the clip member may be removably affixed to the frame member.

In various embodiments of the orthodontic assembly, the frame member has a rigid portion configured to engage an inner portion of the user's mouth and a portion configured to engage at least one of the user's teeth.

In further various embodiments of the orthodontic assembly, the frame member includes a first rigid portion, a second portion, and a flexible intermediate portion provided intermediate to the first rigid portion and the second portion to provide flexibility to the frame member. The intermediate portion may have a flexible c-shaped cross-section configured to provide flexibility to the frame member.

In further various embodiments of the orthodontic assembly, the frame member includes a rigid portion having a first track member and a second track member in spaced relation to each other. The first track member and second track member each extend along an inner portion of the user's mouth and are cooperatively configured to operatively engage one or more clip members.

In further various embodiments of the orthodontic assembly, the frame member includes a first portion configured to engage a first lingual portion of the user's teeth, a second portion configured to engage a second lingual portion of the users' teeth and an adjustment member provided intermediate to the first and second portion to apply a force intermediate to the first and second portion to facilitate expanding the palate.

In further various embodiments of the orthodontic assembly, the frame member includes one or more tab members that extend from an inner portion of the frame member, permitting the frame member to be removably fastened to fixed screws inserted in the user's mouth.

In further various embodiments of the orthodontic assembly, the clip member includes a first portion configured to engage the frame member and a second portion configured to engage one or more of the user's teeth.

In further various embodiments of the orthodontic assembly, the clip member includes a portion configured to operatively engage the frame member and a flexible portion configured to operatively engage the tooth to facilitate tooth movement.

In further various embodiments of the orthodontic assembly, the clip member includes a retentive member configured to engage a portion of one or more of the user's teeth.

In further various embodiments of the orthodontic assembly, the clip member includes a first portion configured to engage a lingual portion of the user's tooth and a second portion configured to engage a buccal portion of the user's tooth.

In further various embodiments of the orthodontic assembly, the clip member includes a governing portion that cooperatively engages a lingual portion and an occlusal portion of the user's tooth to facilitate bite correction and tooth movement.

In further various embodiments of the orthodontic assembly, the first clip member includes a fastening portion that removably cooperatively connects to the frame member and second clip member, and a governing portion that extends over the occlusal surface to the buccal surface of the user's tooth to facilitate bite correction and tooth movement.

In further various embodiments of the orthodontic assembly, the orthodontic assembly further includes a bonded member fastened to at least one tooth, the bonded member configured to cooperatively engage the clip member such that the clip member and connected frame member may be removably affixed to the bonded member, so as to facilitate tooth movement and retention.

In further various embodiments of the orthodontic assembly, the clip member is operatively connected to the frame member and engages two or more teeth to facilitate tooth movement or retention.

In further various embodiments of the orthodontic assembly, the clip member has an engagement portion which includes a first flexible vertical wavelike member and a second flexible vertical wavelike members joined in a middle section to facilitate tooth movement.

In further various embodiments of the orthodontic assembly, the clip member has a flexible engagement portion that includes a plurality of flexible extension members and bristles that extend from the clip to engage and facilitate tooth movement.

In further various embodiments of the orthodontic assembly, the orthodontic assembly further includes a labial bow member that extends along an outer portion of the users' teeth and configured to operatively engage a first clip member connected to a first side of the orthodontic assembly and a second clip member connected to an opposing second side of the orthodontic assembly.

In further various embodiments of the orthodontic assembly, the orthodontic assembly includes at least two clip members, each including an outer lip portion including a locking portion configured to receivably engage a corresponding inner edge of the labial bow member.

In further various embodiments of the orthodontic assembly, the clip member is removably fastenable to an outer portion of the frame member.

In further various embodiments of the orthodontic assembly, the clip member is removably fastenable to an inner portion of the first track member and second track member of the frame member.

In further various embodiments of the orthodontic assembly, the orthodontic assembly, further includes a band member configured to receive a tooth member therein, the banded member configured to cooperatively engage the clip member such that the clip member and connected frame member may be removably affixed to the banded member, so as to facilitate tooth movement and retention

In further various embodiments of the orthodontic assembly, the frame member is positioned proximate to the palatal portion of the user's teeth and the clip member fastenably engages a receiving portion of the frame member and includes a ramp portion configured to engage the opposing teeth in the mouth to facilitate bite correction.

In further various embodiments of the orthodontic assembly, the clip member includes an elastomeric pre-loaded biasing member configured to operatively engage at least one tooth to effectuate tooth movement.

In further various embodiments of the orthodontic assembly, an adjustment member includes a clip with a flexible biasing member configured to exert a force on the first portion and second portion of the frame member so as to facilitate expanding the palate.

In further various embodiments of the orthodontic assembly, an upper assembly includes at least one clip member with a first hook extending in a first direction and a lower assembly includes at least one clip member with a second hook extending in an opposing second direction of the first hook, wherein the first hook and second hook are operatively connected with at least one biasing member so as to facilitate bite correction and tooth movement.

In further various embodiments of the orthodontic assembly, the clip member is provided intermediate to the frame member and user's tooth.

In further various embodiments of the orthodontic assembly, the frame member is configured and manufactured to fit in a selected user's mouth via 3-D printing.

In further various embodiments of the orthodontic assembly, the clip member is configured and manufactured to engage the frame member and tooth via 3-D printing.

In light of the present need for a versatile orthodontic component assembly, a brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

### BRIEF DESCRIPTION OF DRAWINGS

FIG. 1A is an environmental occlusal view of a user's mouth, showing a frame member of an orthodontic assembly positioned about the lingual surface of the user's teeth;

FIG. 1B is an environmental occlusal view of a user's mouth illustrating the orthodontic assembly including the frame member having intermediate portions and a plurality of interchangeable active components and removable clip members operatively engaged with the frame member;

FIG. 1C is a side cross-sectional view of the frame member of FIG. 1B, including an intermediate flexible C-shaped portion provided along a central portion of the frame member;

FIG. 1D is a side cross-sectional view of the frame member of FIG. 1B, illustrating an intermediate flexible helical coil shaped portion provided along a central portion of the frame member;

FIG. 1E is an environmental internal view of the frame member of FIG. 1B, illustrating an intermediate sinusoidal shaped portion provided along a central portion of the frame member;

FIG. 1F is an environmental internal view of the frame member of FIG. 1B, illustrating an intermediate vertical wave-like configuration provided along a central portion of the frame member;

FIG. 2A is an environmental internal view of the orthodontic assembly including the frame member of FIG. 1B and a variety of clip member configurations operatively engaged with a lingual surface of the user's teeth in a first position;

FIG. 2B is a side cross-sectional view of the orthodontic assembly of FIG. 2A and clip member, including a flexible intermediate component;

FIG. 2C is a side cross-sectional view of the orthodontic assembly of FIG. 2A illustrating the clip and screw member fastened to the frame member and operatively engaged with a lingual portion of the user's tooth in a first position;

FIG. 2D is a side cross-sectional view of the orthodontic assembly of FIG. 2A operatively engaged with a lingual portion of the user's tooth showing the tooth moved into a second position;

FIG. 2E is a side cross-sectional view of the orthodontic assembly of FIG. 2A illustrating a clip member having bristle shaped pads components engaged with a tooth;

FIG. 2F is a side cross-sectional view of the orthodontic assembly of FIG. 2A illustrating a clip member having a flexible configuration engaged with a tooth;

FIG. 3A is a side cross-sectional view of another embodiment of the orthodontic assembly, illustrating the frame member and clip member engaged with an over layer of clear shell component covering both frame and clip members and extends to the buccal surface of the tooth to enhance the tooth alignment and retention;

FIG. 3B is a side cross-sectional view of another embodiment of the orthodontic assembly, illustrating the frame member and clip member in operative engagement with the lingual surface and incisal edge of the user's tooth;

FIG. 4A is an environmental side sectional view of the clip member of the orthodontic assembly covering the occlusal surface of the teeth, for facilitating tooth movement and bite alignment;

FIG. 4B is an environmental side sectional view of the clip member covering the occlusal surface of the teeth for facilitating teeth movement and bite alignment;

FIG. 4C is top occlusal view of the orthodontic assembly and clip member of FIG. 4A, illustrating the governing portion extending over the tooth to facilitate teeth movement and bite alignment;

FIG. 5A is a side cross-sectional view of another embodiment of the orthodontic assembly including a clip member having a contoured C-shaped configuration with a flexible portion operatively engaging an undercut of the lingual portion of the user's tooth;

FIG. 5B is a lingual side view of the orthodontic assembly and clip member of FIG. 5 A, engaged with a lingual portion of the tooth illustrating a clip member with leaves connected thereto;

FIG. 6A is an occlusal partial top view of an embodiment of the orthodontic assembly, illustrating a clip member operatively engaged with a member in bonded connection with a user's tooth;

FIG. 6B is a side cross sectional view of the orthodontic assembly of FIG. 6A, illustrating the clip and frame members and bonded member in an operatively engaged connection;

FIG. 6C is a lingual side view of the orthodontic assembly of FIG. 6A engaged with the lingual surface of the user's tooth;

FIG. 7A is a top view of another embodiment of the orthodontic assembly illustrating a bonded member operatively engaged with a tooth;

FIG. 7B is a side cross sectional view of the orthodontic assembly of FIG. 7A, illustrating a wire member in operative engagement with the bonded member;

FIG. 7C is a side cross sectional view of the orthodontic assembly of FIG. 7A, illustrating another embodiment of the bonded member;

FIG. 8A is a lingual view of an orthodontic assembly including a bonded member and clip member having a biasing component for tooth movement and retention;

FIG. 8B is a lingual view of an orthodontic assembly of FIG. 8A illustrating the biasing component in an extended position;

FIG. 8C is a top view of the orthodontic assembly of FIG. 8A;

FIG. 8D is another embodiment of the orthodontic assembly including a bonded member and a wave like biasing member;

FIG. 9 is an environmental top view of the occlusal surface of a user's mouth illustrating another embodiment of the orthodontic assembly including an embodiment of a track frame member, positioned about the lingual portion of the user's teeth;

FIG. 10A is a cross-sectional side view of the orthodontic assembly of FIG. 9, illustrating the frame member and clip member operatively engaged with a tooth;

FIG. 10B is lingual perspective view of the orthodontic assembly of FIG. 9 illustrating the clip member with operative engagement with the frame member

FIG. 11A is a lingual perspective view of an embodiment of an orthodontic assembly illustrating the track frame member of FIG. 9 and a sliding clip member connected to a biasing member;

FIG. 11B is a cross-sectional side view of the sliding clip member of FIG. 11A configured for operative engagement with a track frame member;

FIG. 11C is an occlusal environmental view of the orthodontic assembly of FIG. 11A;

FIG. 11D is a lingual perspective view of an embodiment of an orthodontic assembly illustrating the track frame member of FIG. 11A and a sliding clip member connected to a biasing member using elastic bands for tooth movement;

FIG. 11E is an occlusal environmental view of the orthodontic assembly of FIG. 11D;

FIG. 12A is a cross sectional side view of a pre-loaded biasing clip member connected to the track frame member of FIG. 9, providing a biasing force on an engaged tooth;

FIG. 12B is an environmental lingual view of the pre-loaded biasing clip member and frame track member interconnected;

FIG. 13A is a cross sectional side perspective view of an embodiment of an orthodontic assembly including a clip member engaged with a frame member positioned on a palatal surface for engagement with the lower incisors to facilitate bite correction.

FIG. 13B is an occlusal top view of the upper palate illustrating the orthodontic assembly and clip member of FIG. 13A positioned in the frame;

FIG. 13C is a lateral, side view of the hooks component originating from a frame or clips on the frame (not shown) of the upper and lower arches and connected with elastic rubber bands for bite correction;

FIG. 13D is a lateral, side view of components originating from a frame or clips on the frame (not shown) of the upper and lower arches and connected with a spring for bite correction.

FIG. 14A is an environmental top view of an embodiment of an orthodontic assembly provided on a palatal surface of the mouth, including an adjustment member for expanding the palate using a spring clip;

FIG. 14B is an environmental top view of an embodiment of an orthodontic assembly provided on a palatal surface of the mouth for expanding the palate using a screw clip member;

FIG. 14C is environmental view of a clip member removably insertable into a portion of the adjustment member of 14A;

FIG. 15A is a frontal view of a labial bow member attached to a special design component;

FIG. 15B is a frontal view of another embodiment of the labial bow member configured to connect to a special component in FIG. 15A,

FIG. 15C is a frontal view of another embodiment of the labial bow elastic module member configured to connect to a special component in FIG. 15A,

FIG. 15D is a frontal view of another embodiment of the labial bow member illustrating decorative features.

FIG. 15E is a detailed frontal view of the special configure component in FIG. 15A and labial bow member connection;

FIG. 15F is an exploded detailed view of the special configure component and labial bow member connection of FIG. 15E;

FIG. 15G is another embodiment of the orthodontic assembly including a labial bow member assembly;

FIG. 15H is a side cross sectional view of the orthodontic assembly of FIG. 15G, illustrating the labial bow member and clip member connection;

FIG. 15I is a top sectional view of the orthodontic assembly of 15G, illustrating the labial bow member and the clip member connection;

FIG. 15J is a frontal view of the orthodontic assembly of 15G, illustrating the labial bow member and the clip member connection;

FIG. 16A is an environmental occlusal view of another embodiment of the orthodontic assembly positioned about the lingual surface of the user's teeth and engaged with a band member for retaining the frame member therein;

FIG. 16B is a cross-sectional view of the band member and clip member and frame member connection;

FIG. 17A is an occlusal view of another embodiment of an orthodontic assembly having a temporary anchorage device supported frame;

FIG. 17B is a cross-sectional view of a part of the frame member of FIG. 17A operatively connected to an inner portion of the user's mouth and temporary anchorage device

To facilitate understanding, identical reference numerals have been used to designate elements having substantially the same or similar structure and/or substantially the same or similar function.

### DETAILED DESCRIPTION

As previously discussed, conventional fixed orthodontic assemblies are undesirable esthetically; pose difficulties for the user to maintain good oral hygiene; and do not provide the precision and customization needed to selectively exert a force on a particular tooth, or group of teeth. One of the inherent disadvantages to existing removable appliances relates to the difficulty of fabrication and limitations related to the application of force on the teeth, as discussed previously. Accordingly, it is desirable to use a removable orthodontic assembly that is not uniform in its construction and application of force on the teeth. Such a removable orthodontic assembly provides an esthetic alternative to a fixed orthodontic assembly in that it can be removed from the mouth to permit proper oral hygiene care or removed for limited periods of time for the user's esthetic preferences (for example, when attending a formal event). When configured with versatile flexible components, a removable orthodontic assembly can exert precise force on one or more selected teeth and reduce the force exerted on teeth excluded from treatment. The components can be changed with subsequent movement of the teeth and/or changes to the bite without the need to replace the entire appliance. It is also desirable to have a removable retainer assembly with flexible components that is incorporated into the frame assembly. Such an assembly can be used to allow desirable teeth settling following fixed orthodontic treatment and to regain minor tooth movement as teeth shift and relapse to an undesirable position due to poor retainer wear by the user.

3-D printing of embodiments of the orthodontic assembly provides versatility with one or more interchangeable clip members which may include the combination of a single extension, plural extensions, bristles pads, rests, clasps, occlusal coverage, or any other desirable component to precisely engage any part of the selected tooth or teeth, aid in securing the assembly on the teeth or in the mouth, or have components that are used to aid in teeth alignment, bite correction and/or habit modification. Further, 3-D printing of the orthodontic assembly provides customizable clip members having a variety of selected sizes, materials, shapes, directions, thickness, flexibility, configurations, and extensions, which may vary depending upon the dental practitioners/installers' desired treatment results.

3-D printing of embodiments of the orthodontic assembly provides versatility in fabricating a frame member, designed to allow attachment of a clip or group of clips, and having a variety of selected sizes, materials, shapes, directions, thickness, flexibility, configurations, and extensions. 3-D printing of embodiments of the orthodontic assembly provides versatility in fabricating the frame member with intermediate flexible parts or with any other flexible components to be positioned directly or indirectly on the teeth, which may include the combination of a single extension, plural extensions, bristles, rests, clasps, occlusal coverage, or any other desirable component to precisely engage any part or parts of the selected tooth or teeth, aid in securing the assembly on the teeth or in the mouth, or have components that are used to aid in teeth movement, bite correction, and/or habit modification.

3-D printing of embodiments of the orthodontic assembly provides versatility with frame assembly. This versatility allows the assembly to achieve desirable teeth settling following fixed orthodontic treatment and regain minor tooth movement as teeth shift and relapse due to undesirable positions caused by poor retainer wear by the user. The foregoing are illustrative of those that may be achieved by the various exemplary embodiments and are not intended to be exhaustive or limiting of the possible features which may be realized. Thus, these and other features of the various embodiments will be apparent from the description herein or can be learned from practicing the various embodiments, both as embodied herein or as modified in view of any variation that may be apparent to those skilled in the art. Accordingly, the invention resides in the novel methods, arrangements, combinations, and improvements herein shown and described in various exemplary embodiments. To facilitate understanding, identical reference numerals have been used to designate elements having substantially the same or similar structure and/or substantially the same or similar function

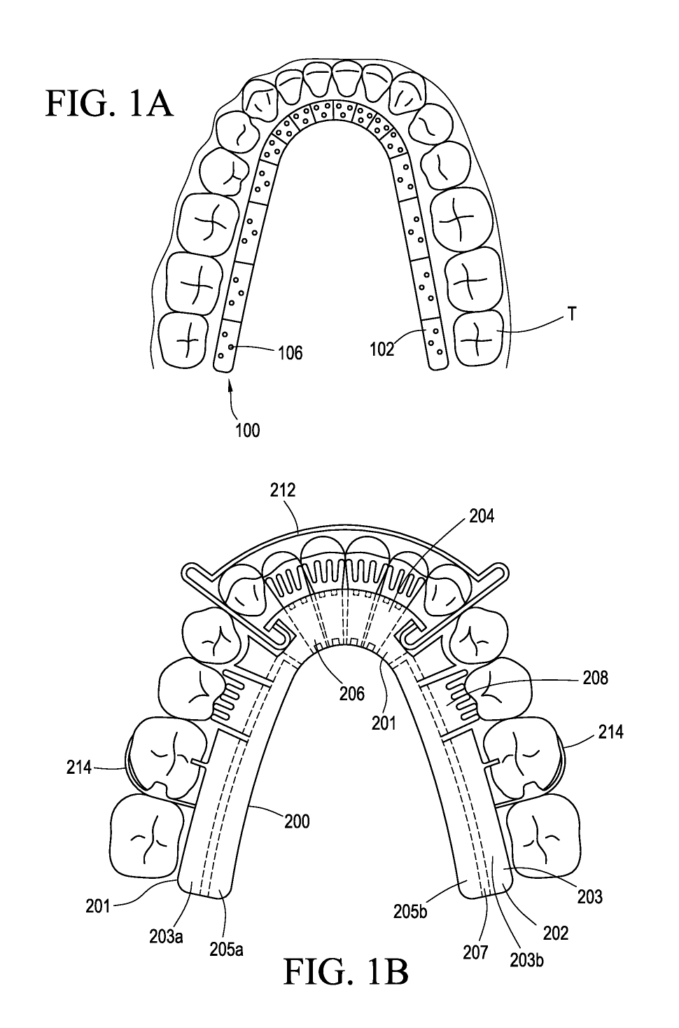

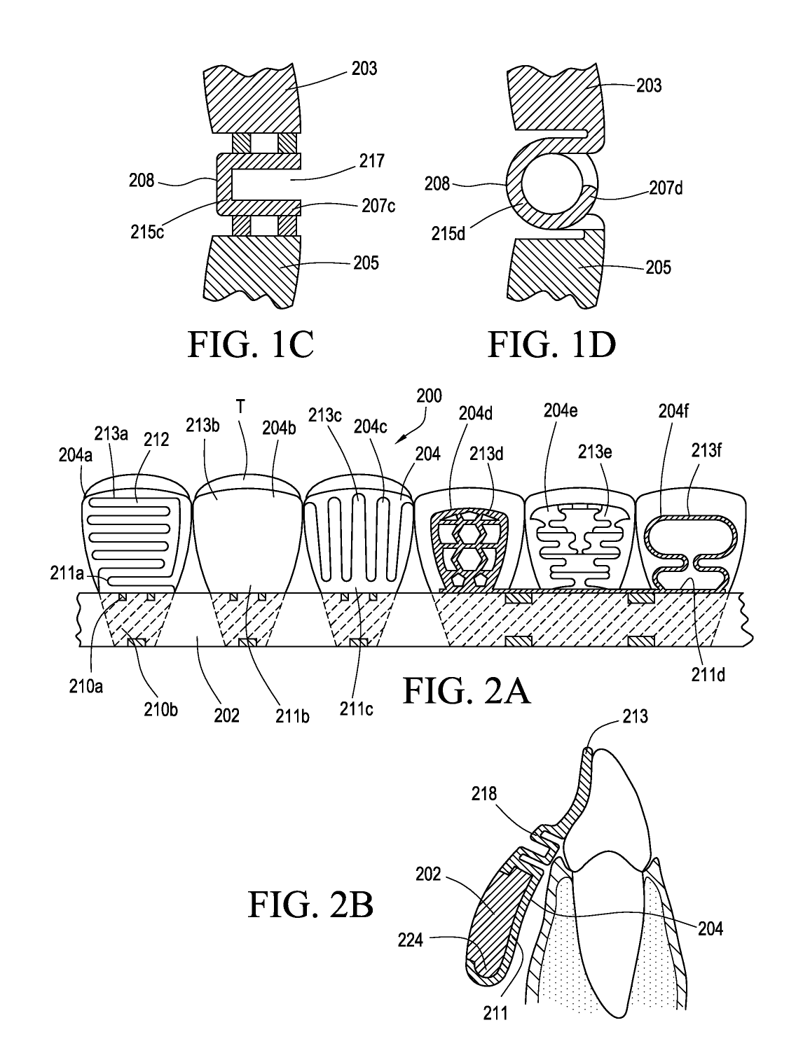

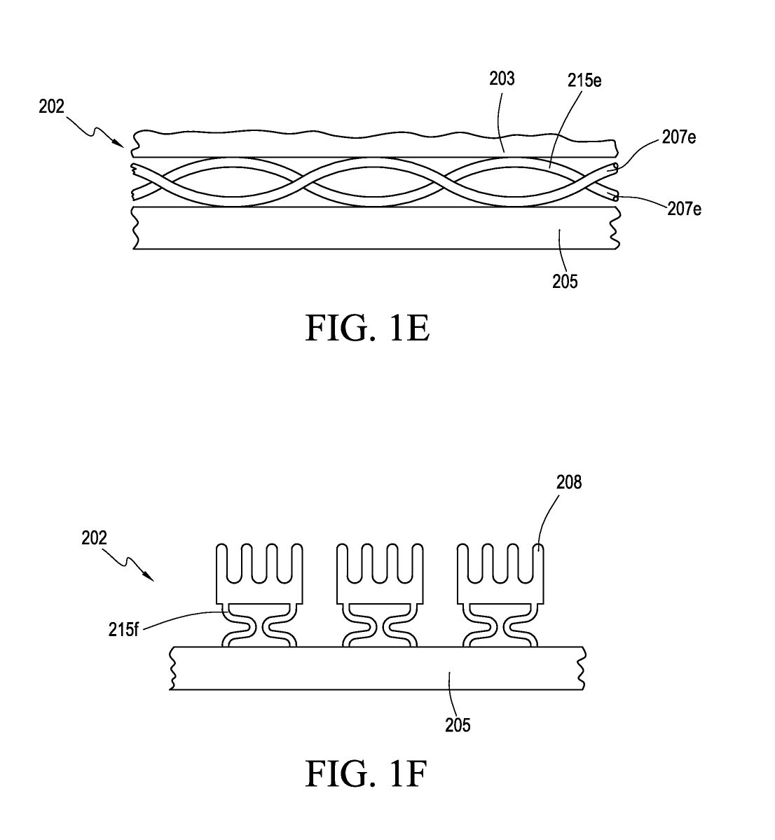

Referring now to the drawings, wherein the illustrations are for purposes of describing one or more embodiments and not for the purposes of limiting the same, FIGS. 1A and 1B illustrate an embodiment of the orthodontic assembly 100. FIG. 1A is configured for facilitating tooth movement, and/or tooth retention, when positioned in operative engagement in the user's mouth and teeth T. The orthodontic assembly 100 generally includes a frame member 102, and one or more clip members 104 (not shown), removably attachable to the frame member 102. The clip member 104 may be connected to the frame member 102 using a variety of fastening features, such as a snap-fit connection, or a screw fastener, for example.

The frame member 102 has a generally arcuate or U-shaped configuration, which via 3-D printing may include a rigid and/or a semi-rigid structure that is configurable to conform to the upper and/or lower palate of a user's mouth. Accordingly, via 3-D printing, the frame member 102 may be selectively customized for the user by scanning the interior of the user's mouth, and forming the frame member's structure based on the topography and/or shape of the interior of the user's mouth detected by the 3-D printer scan.

Notably it is contemplated that tooth movement may be effectuated using a “virtual tooth movement process.” In this process, the user's teeth are scanned at several preselected views. A virtual mold of the user's teeth is then created and the user's teeth are then virtually moved in images and to create a series of virtual molds upon which the orthodontic assembly is virtually created and printed. The Printed components of the assembly have a number and/or a letter to facilitate the assembly and subsequent replacement of the components.

Accordingly, the frame member 102 may be comprised of. but not limited to, metal, photo-hardening polymer and/or a variety of different material conducive for 3-D printing. It is contemplated that the 3-D printing methods used for manufacturing the frame member 102 may include, however are not limited to, fused deposition modeling, as well as, additive manufacturing processes for metal sintering, such as selective laser sintering, direct metal laser sintering or selective laser sintering, for example. Notably, other known 3-D printing methods used to manufacture metal and/or polymer devices, similar to the frame member 102, clip members 104 and other active components of the orthodontic assembly 100 are contemplated

The frame member 102 is configured to receive one or more clip members 104 and other attachable components in a variety of configurations. As illustrated, the frame member 102 may include one or more extrusions and/or grooves 106 that are adaptable to receivably fasten a portion of the clip member 104 to the frame member 102. Similar to the frame member 102, the clip member 104 and other interchangeable components, may be configured using 3-D printing methods. The clip member 104 and components are configurable via 3D printing such that when the selected clip member 104 is fastened to the frame member 102 it exerts a pre-selected biasing force on the user's teeth based on the manufactured shape

FIG. 1B illustrates an embodiment of the orthodontic assembly 200, similar to that of the orthodontic assembly 100 illustrated in FIG. 1A. The orthodontic assembly 200 illustrated in FIG. 1B may be comprised of a combination of flexible portions, semi-flexible portions and rigid portions integrally connected together with flexible intermediate connectors. As illustrated in FIG. 1B, the orthodontic assembly 200 may include a combination of different components to facilitate tooth retention and/or movement. The components of the assembly may include, but are not limited to, one or more interchangeable clip members 204, one or more retainer members 212, one or more C-clasp member 214, and one or more force elements 208, which may be integrally connected to the frame member 202 or connected by intermediate flexible connector, to operatively engage the tooth. Notably, these components may be selectively configured and manufactured via 3-D printing. Different materials can be incorporated into the fabrication of the orthodontic assembly such that the different components can be made of different materials. An example of this multi-material fabrication would be the fabrication of flexible titanium alloy active components, while fabricating other components of the assembly with polymeric materials. As part of this fabrication process, after initial fabrication of the 3D-printed first part, it is scanned and the second or same machine is calibrated with the 3D geometry of the first part to fabricate the second part by adding and building/mounting new and different material(s) in a preselected area so that the first part is imbedded and retained in the new material.

The frame member 202 may include a variety of different connection points and different levels of rigidity, and may be constructed from different materials which can be facilitated by 3-D printing. Accordingly, the frame member 202 may be a rigid or semi-rigid structure of virtually any shape, size, or thickness that, directly or indirectly via the clip members 204 and other components such as intermediate connectors, facilitate tooth movement, retention, support, habit modification and/or teeth and jaw alignment. Similar to the aforementioned embodiments, the frame member 202 may be manufactured using 3-D printing methods to provide a precise and conforming fit with the user's mouth.

The frame member 202 is customizable to the user. As illustrated in FIG. 1B, the frame assembly 202 may include an upper portions 203a, 203b positioned proximate to the teeth T, a lower portions 205a and 205b positioned proximate to the user's palate, front portion 201 connected together with a flexible intermediate portion 207. As previously discussed, the frame assembly 202 is customizable via 3-D printing, thus any of the portions 203a, 203b, 205a, 205b, 201 and 207 of the frame assembly 202 may be selectively configured with a variable range of rigidity and materials during manufacturing.

FIGS. 1C-1D are cross-sectional views of embodiments of the frame assembly 202 of the orthodontic assembly 200. As illustrated in FIG. 1C, the intermediate portion 207c of the frame assembly 202 may include a flexible C-shaped element 215c positioned between the top portion 203 and lower portion 205 of the frame assembly 202. The C-shaped structure provides a gap or opening 217 formed therein permitting the structure 207c and connected frame assembly 202 to bend or flex when inserted in the user's mouth thereby providing sufficient force to move the tooth or teeth into a selected position through the upper portion 203 of the frame assembly 202.

FIG. 1D is a cross-sectional view of another embodiment of the orthodontic assembly 200 and frame assembly 202. The frame member 202 may have a generally flexible helically-coiled element 215d provided generally at the intermediate portion 207d between upper portion 203 and lower portion 205 of the frame assembly 202. Similar to the aforementioned embodiment, the helically-coiled element 215d bends when the assembly is inserted in the user's mouth therefore providing the force to move the tooth or teeth into a selected position through the upper portion 203 of the frame assembly 202. FIG. 1E is lingual view of another embodiment of the orthodontic assembly 200 and frame assembly 202. Similar to aforementioned embodiments, the frame assembly 202 has upper portion 203 and a lower portion 205 and an intermediate flexible element 215e positioned at the intermediate portion 207e, between the upper portion 203 and lower portion 205. As illustrated, the flexible element 215e includes one or more generally horizontally positioned sinusoidal wave-like structure 215e that weave between the upper portion 203 and lower portion 205 of the frame assembly 202, providing the frame assembly 202 with flexibility.

FIG. 1F illustrates another embodiment of the frame assembly 202 and orthodontic assembly 200. The active component is operatively connected to the frame assembly 202 by one or more vertically aligned sinusoidal wave-like elements 215f. This flexible integral connection permits the active component to flex relative to the frame member 205. As illustrated in this embodiment, two wave-like elements 215f extend between the frame member 205 and active component 208. Notably, more than two wave-like elements 215f may be provided to control the rigidity and flexibility of the intermediate part. Similar design can be incorporated into clip assembly for added flexibility.

The clip members 204 are customizable interchangeable components capable of being removably connectable to the frame member 201 or the frame assembly 202. The clip members 204 may be manufactured via 3-D printing. This permits the manufacturer to selectively customize the rigidity and flexibility and the material of the clip members 204 in accordance with the user's needs.

The clip member 204 may be configured for a different functions including but not limited to selectively exert a force on the tooth T or selected teeth, in order to facilitate tooth movement, retention, bite correction and/or habit modification. The clip members 204 may include flexible components for exerting a biasing force on the engaged tooth or teeth. Accordingly the clip member 204 is configured to bend or flex when the orthodontic assembly 200 is positioned in the user's mouth.

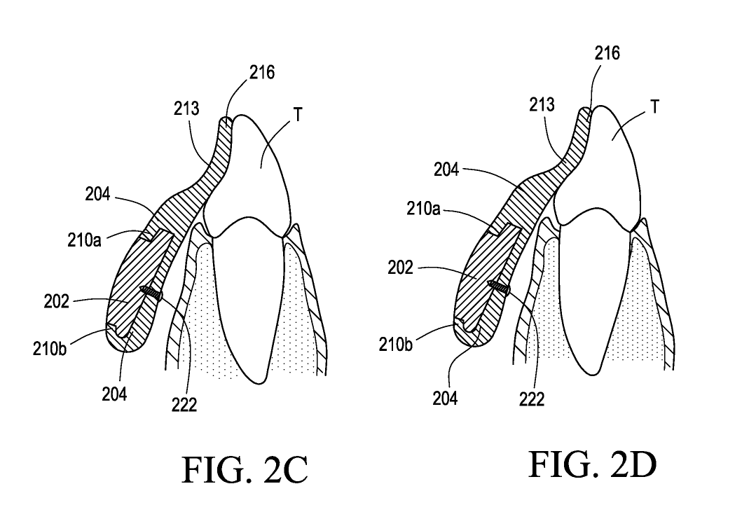

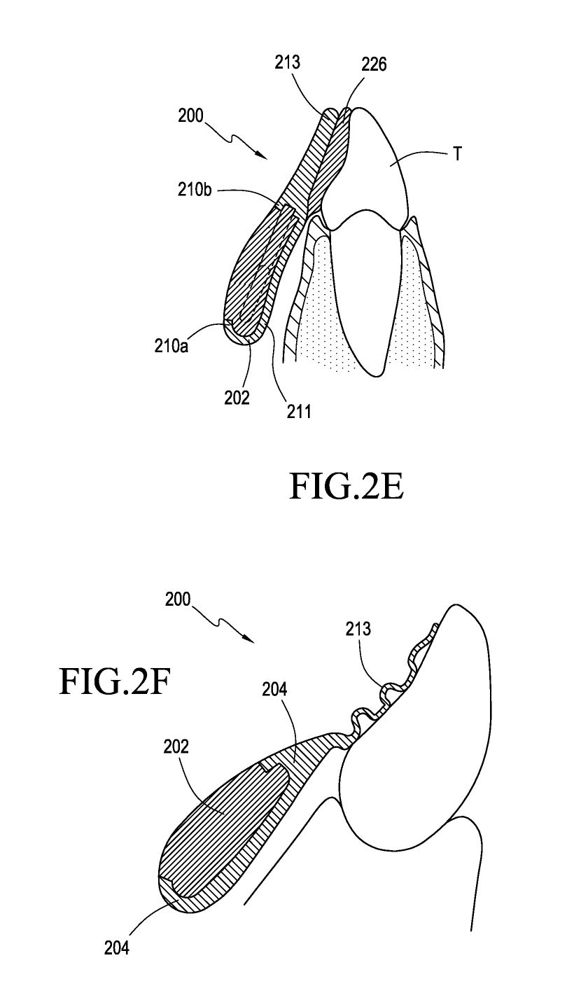

FIG. 2A illustrates a plurality of clip members 204a-f having a variety of configurations, connected to the frame member 202 for effectuating tooth movement/tooth retention. As shown, each clip member 204 a-f may include a base portion 211a-f configured for fastenable engagement with the frame member 202, and a head or leaves portion 213a-f configured for operative engagement with the tooth T. As you seen in FIG. 2B after the base portion 211 the rest of the clip may rest on the entire surface of the tooth, and accordingly is not limited to only the head portion.

As illustrated, the head portions 213a-f of the clip members 204a-f may have a variety of configurations to selectively distribute forces exerted on the tooth T by orthodontic assembly 200. For example, the clip member 204b may be a singular flexible member 213b that substantially engages a lingual portion of the tooth T. In other examples, the respective clip members 204c and 204a may include a group of smaller flexible vertical extension members/leaves 213c or horizontal extension members 213a that cooperatively engage the surface of a tooth T to effectuate tooth movement or retention. The head member 213f includes two flexible vertical wavelike members joined together in a middle section. As shown, head members 213d and 213e have multiple flexible members joined with a pattern.

Accordingly, it is contemplated that virtually any clip member 213 shape or configuration can be designed to effectuate tooth movement or retention

It is contemplated that the head portions 213a and 213c of the respective clip members 204a and 204c, may be constructed to cover approximately the same surface of the tooth T as the singular flexible member 213b of the clip member 204b. The contact surface area between the active part of the clip member and the tooth surface may vary and depend on, the shape of the tooth, the amount of force and direction of force needed to effectuate tooth movement, and contact with the opposing tooth or teeth T. The contact surface area is not limited to the above-mentioned factors.

The head portions 213a and 213c provide the respective clip members 204a and 204c with a plurality of flexible thin extension members engaged on the lingual portion of the tooth T. The head portions 213a and 213c may be configured to exert precise forces at selected locations on the tooth T. The tip of the clip member may provide most of the force but the rest of the clip can also provide force transitioning toward the base of the clip member.

Most typical singular plate members are relatively rigid. In contrast, as illustrated in FIG. 2B, the singular plate clip member 204 may include a flexible intermediate portion or feature 218 connected to an extension or leave member 213. Notably, multiple flexible intermediate features, or similar flexible features, 218 may be added to the clip to enhance flexibility, as illustrated in FIG. 2F. As shown in the clip member 204f has an upper engagement portion 213f which includes a first curved member that engages an outer portion of the selected tooth and a second curved member that engages an opposing outer portion of the selected tooth to facilitate provide added flexibility.

Notably, it is contemplated that the clip member 204 and other engagement components in cooperation with the flexible feature 218 will have the flexibility to be provided as a singular flexible plate member that engages one tooth T.

As shown in FIG. 2B-2E the clip member 204 may be removably fastenable to the frame member 202 using a snap-fit connection. As shown the clip member 204 may include fastening members 210a-b and an opening 224 provided there between for receiving a portion of the frame member 202 therein. Additionally, one or more screws or fasteners 222 may be used to further secure the clip member 204 to the frame member 202.

As illustrated in FIGS. 2C and 2D, tooth movement can be achieved by interchanging different shaped clip members 204 with the frame member 202 to selectively control the biasing force exerted to the tooth T. In one example, a portion of the frame member 202 is received within the respective fastening members 210a and 210b of the clip member 204. As such the connecting features 210a and 210b engage the frame member 202, thereby providing a secure snap-fit connection between the clip member 204 and the frame member 202, as shown.

The clip member 204 may be configured to provide force to the tooth T at precise locations on the tooth T. As illustrated in FIG. 2E, the clip member 204 may include a plurality of bristles pads 226 that extend outward from the head or leaves portion 213 applying an engaging force to engage the tooth T. The bristles pads 226 may be configured with any shape to enhance the contact surface area between the orthodontic assembly 200 and the tooth T.

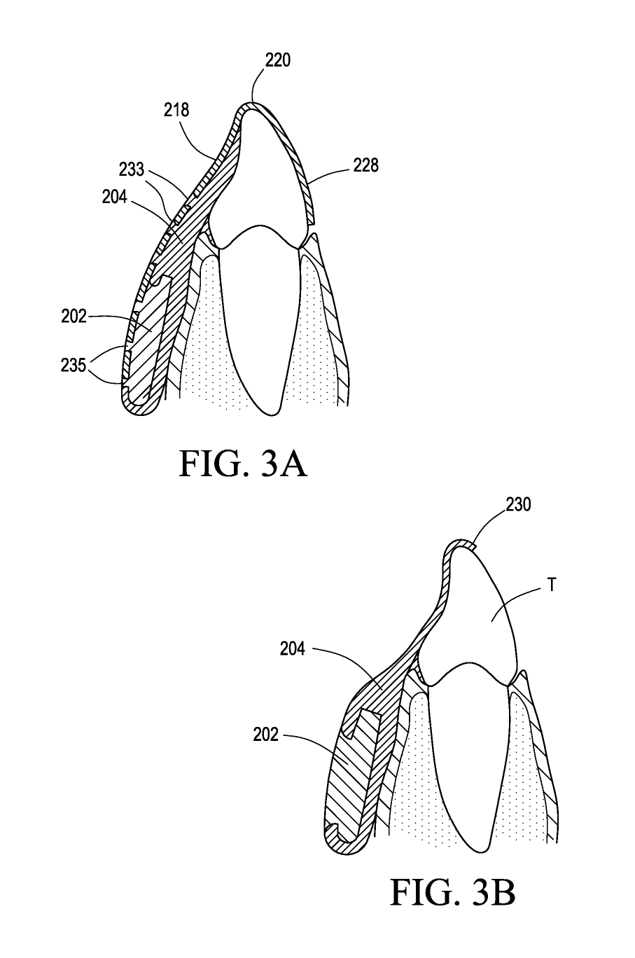

In an embodiment illustrated in FIGS. 3A and 3B, the orthodontic assembly 200 provides occlusal coverage of one or more teeth T to facilitate tooth movement and retention. As illustrated in FIG. 3A, the outer surface of the clip member 204, the frame member 202 and the remaining tooth surfaces are covered by a generally thin, governing member 220 that may be configured to cover in addition to the clip and frame a portion of the tooth, the entire tooth, a group of teeth, or the entire arch, to facilitate tooth movement and/or retention. The thin clear shell governing member 220 is locked into corresponding locking parts on the outside part of the frame and clip through a corresponding grooves or holes in addition to the any other retentive part on the teeth

As illustrated, the clip member 204 is configured for engagement with the tooth T and the frame member 202. The clip member 204 may be made of metal and/or polymer, or any other desirable material. The governing member 220 provides a shell that includes a series of openings 233 and 235 formed about the outer portions of the respective clip member 204 and frame member 202. Accordingly, the governing member 220 fastenably engages the outer portion of the frame member 202 and clip member 204 and respective extrusions 235 and 233 locking the shell in to the frame member 202 and clip member 204. Alternatively, the governing member 220 may extend and cover the extrusions 235 and 233 and lock the shell into the frame and clip members for added retention. The governing member 220 generally includes a first governing portion 218 that is configured for cooperative engagement with a lingual surface of the tooth T, as well as the outer surface of the clip member 204 and frame member 202. The governing member 220 further includes a second governing portion 228 that covers the buccal surface of the tooth T.

The governing member 220 is fastenable to the frame member 202 and clip member 204, covering both members and may extend over the rest of the tooth, adjacent teeth or the entire arch. To enhance aesthetics, it is contemplated that the governing member 220 may be made of a generally clear polymer material.

As illustrated in FIG. 3B, clip member 204 may also be configured to partially engage the incisal edge of the tooth T with an extension portion or governing member 230 to effectuate occlusal coverage. Regarding FIGS. 3A and 3B, the occlusal coverage configuration of the clip members 204 may facilitate a variety of functions, including, but not limited to facilitating tooth movement, opening or deepening of the user's bite, reducing occlusal interferences during the tooth movement process, as well as further protecting the user's teeth from grinding or bruxism.

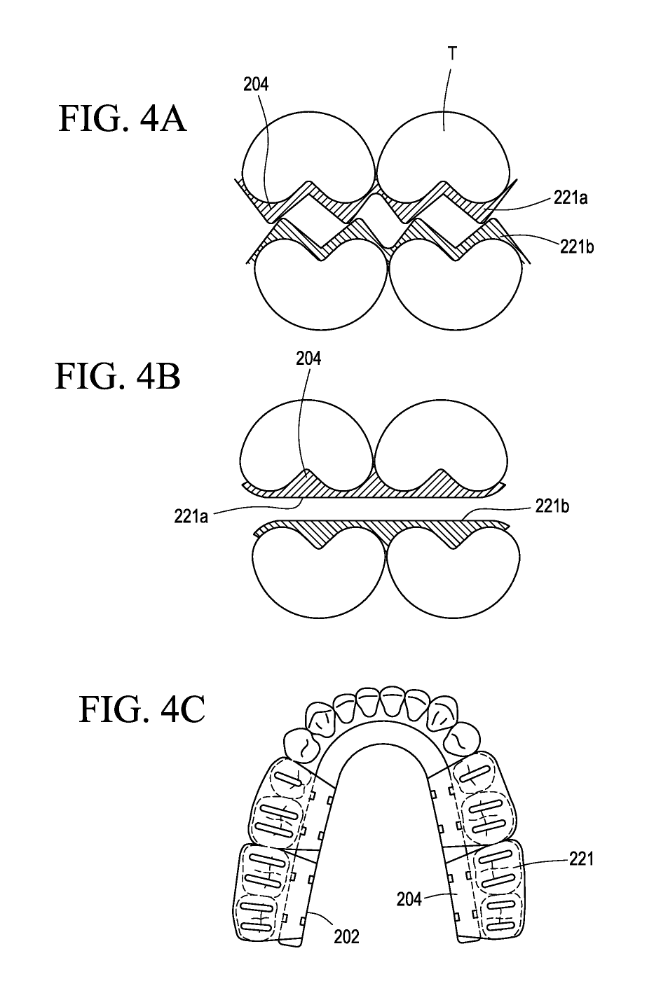

In an embodiment shown in FIGS. 4A-4C, the frame member 202 or the clip member 204 may include a governing portion 221a, 221b that provides occlusal coverage of the posterior teeth T to aid in teeth movement or in bite correction for the user. FIG. 4A illustrates a pre-selected desired shape of occlusal surface of the teeth T. As illustrated in FIG. 4A, the governing portion 221a may be configured via 3-D printing to guide the bite into a favorable position when the user bites down on the governing portion 221b so as to effectuate bite correction. A series of governing portions may be needed to guide the bite into its final position.

As illustrated in FIG. 4B, the governing portions 221a and 221b may be a generally smooth surface, match the occlusal or lingual shape of the teeth or pre-selected shape to guide the teeth into a different and more desirable bite, therefore facilitating bite correction. The pre-selected shape for occlusal coverage can be progressively incorporated into new clips to ensure that the changes occur at a desirable speed according to the patient's adaptation to the new bite. Similar to the other components disclosed herein, shaping of the clip member 204 and governing portions 221a, 221b to provide accurate and optimal occlusal coverage may be achieved via 3-D printing.

As illustrated in FIG. 4C, the governing portion 221 extends from the clip member 204 over the tooth T, such that when a user bites down, the lower jaw slides into a pre-selected position based on the shape and position of the governing members covering the upper and lower teeth surfaces.

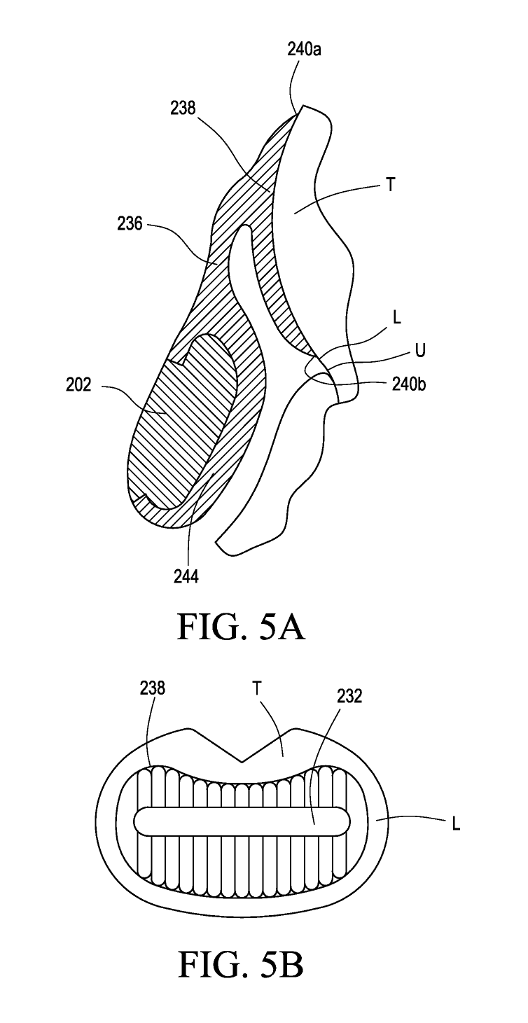

In an embodiment illustrated in FIGS. 5A-5B, the orthodontic assembly 200 includes a frame member 202 and one or more a clip members 244 operatively connectable thereto. The clip member 244 generally includes a stem portion 236 and a C-shaped extension member 238, contoured to engage the lingual surface of the tooth T. The C-shaped extension member 238 extends generally from the mid-portion 232 of the clip member 244, providing a contoured surface that engages the outer contour of the tooth T. As shown, the C-shaped extension member 238 may include tapering tips 240a, 240b, provided generally on both ends of the clip member 244. Notably, it is contemplated that the C-shaped configuration of the clip member 244 may also be used to engage the gingival area of posterior teeth T for added retention, if desired.

One advantage of the orthodontic assembly 200 and C-shaped clip member 244 arrangement is that the clip member 244 is capable of engaging the undercut on the lingual surface L of the teeth T, as illustrated. The lingual engagement type of engagement is another benefit that the orthodontic assembly 200 provides. Other fixed orthodontic assemblies are usually blocked from engaging the area under the contour of the tooth which is called the “undercut area” U, as shown in FIG. 5A

Teeth movement and retention may also be facilitated and/or improved by using bonded components or banded components attached directly to the specific tooth or teeth designated for treatment. It is contemplated that the components may have virtually any shape or size desired and may be fabricated using 3-D printing methods or other fabrication methods. It is further contemplated that the components may be comprised of virtually any material and may be bonded or otherwise attached to any part of tooth. For example, a bonded member on the tooth T may engage a leaf, a wire, or a plate attached to a clip member. In another example the bonded member provided on the tooth T may directly engage the frame member of the orthodontic assembly.

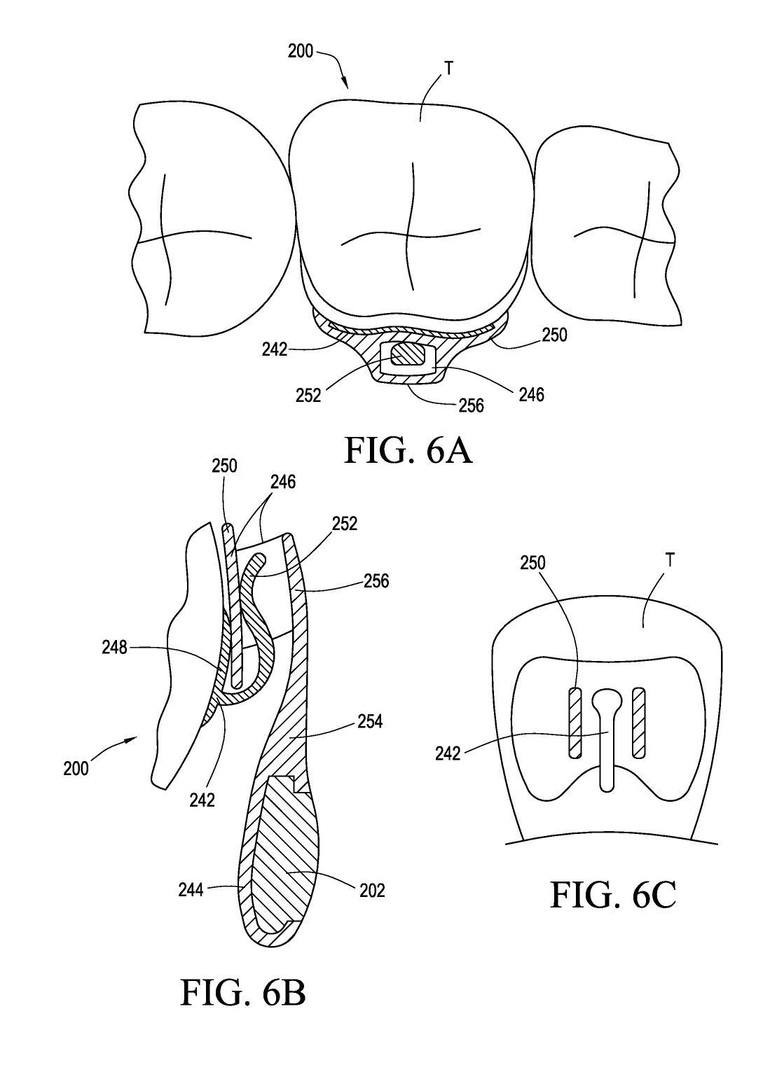

In an embodiment illustrated in FIG. 6A-C, the orthodontic assembly 200 includes a frame member 202, one or more clip members 244, and one or more bonded components 242 configured to receive operative engagement with the respective clip members 244. As illustrated, the orthodontic assembly 200 may be provided along the lingual surface of the tooth T. As such, the bonded component 242 may be connected directly to the tooth T, via connection features such as bonding agents.

As illustrated in FIG. 6B, the clip member 244 generally includes an engagement feature 250, which may have a contoured C-shaped surface complementary to the outer surface of the tooth T and interior surface 248 of the bonded component 242. As illustrated, an opening 246 is provided between the engagement component 250 and the upper portion 256 of the clip member 244. The opening 246 formed between the engagement component 250 and the upper portion 256 is configured for receiving therein the connecting feature 252 of the bonded component 242, forming a connection between the engagement bonded component 242 and the clip member 244. In an inserted position, the bonded component 242 helps secure the clip member 244 onto the tooth T. As such, the clip member 244 exerts a force on the bonded component 242 and directly to the tooth T. The force and direction applied to the tooth T may be adjusted by incrementally adjusting the shape of the clip member 244 provided for connection with the bonded member 242. Similar to the aforementioned clip members, adjustment and replacement of the clip member 244 to achieve a desired movement of the tooth T may be achieved by 3-D printing various customized clip members.

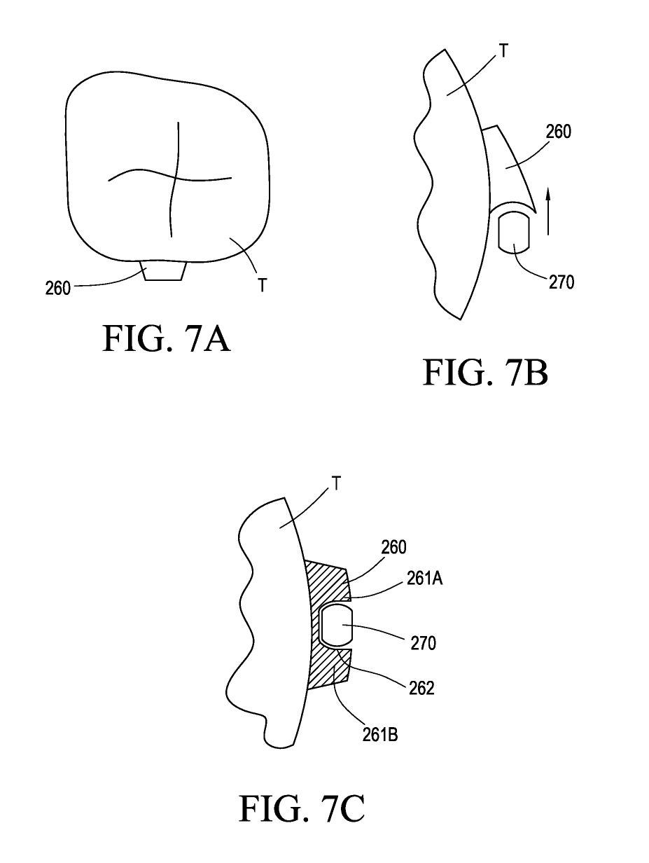

In another embodiment shown in FIGS. 7A-C, the assembly 200 may further include a bonded component 260, which may be connected directly to the outer surface of the tooth T. The assembly 200 further includes a wire or biasing member 270 which, in connection with a connected frame member 200 (not shown), exerts a force on the connected bonded component 260 to facilitate movement of the connected tooth T or for retention. The wire or biasing member 270 may be fabricated using 3-D printing or any other fabrication methods. As illustrated in FIG. 7C, the bonded component 260 may include a first portion 261a and a second portion 261b, and a groove 262 formed therebetween configured to receive the first portion the biasing member 270 therein to effectuate tooth movement or retention

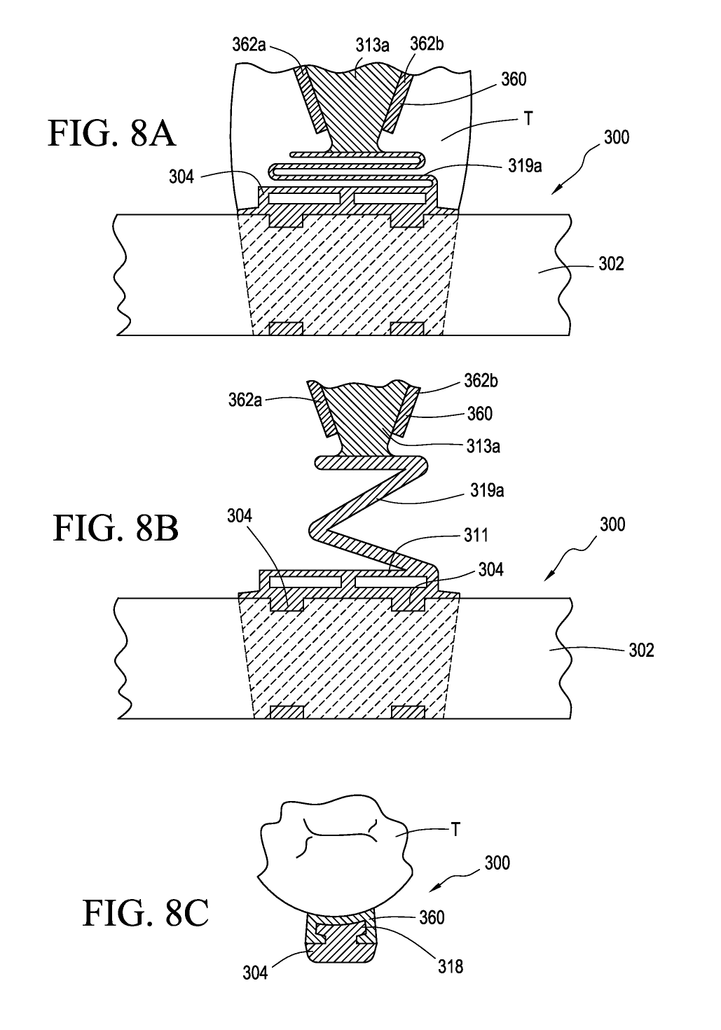

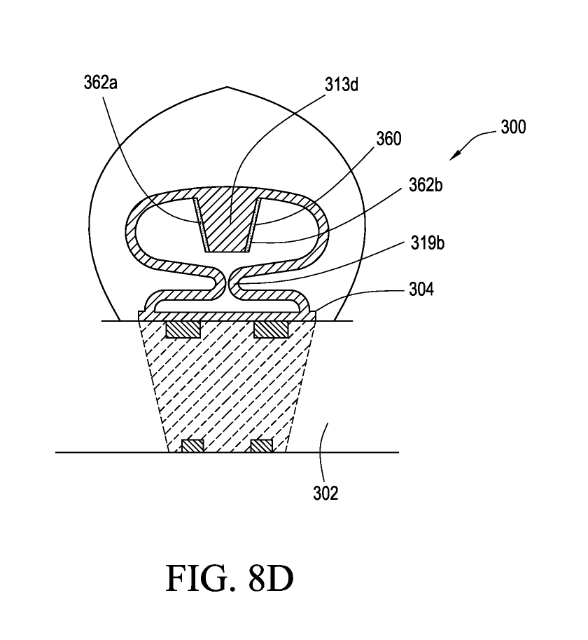

In an embodiment illustrated in FIGS. 8A-D, the orthodontic assembly 300 includes a frame member 302, a clip member 304 removably connectable to the frame member 302, and one or more bonded members 360 to achieve tooth movement. As illustrated, the bonded member 360 is connected to the tooth T. The bonded member 360 includes dual engagement members 362a, 362b formed in a v-shaped configuration for receiving the clip member 304 therebetween.

The clip member 304 generally includes a head portion 313a operatively connected to a spring or biasing member 319a, and a base member 311. Similar to the aforementioned embodiments, the clip member 304 may have a snap-fit connection with the frame member 302. The head member 313a has a v-shaped configuration for insertion between the dual engagement members 362a, 362b, of the bonded member 360. In an inserted position with the dual engagement members 362a, 362b, the head member 313a and the biasing member 319a in cooperation with the clip member 304 and frame member 302 exerts a force on the bonded member 360, thereby exerting a force on the connected tooth T. As illustrated in FIG. 8D, the biasing member 319b may have dual flexible members for exerting a force on the bonded member 360 and tooth member T. The head member 313d is inserted between the dual engagement members 362a, 362b of the bonded member 360

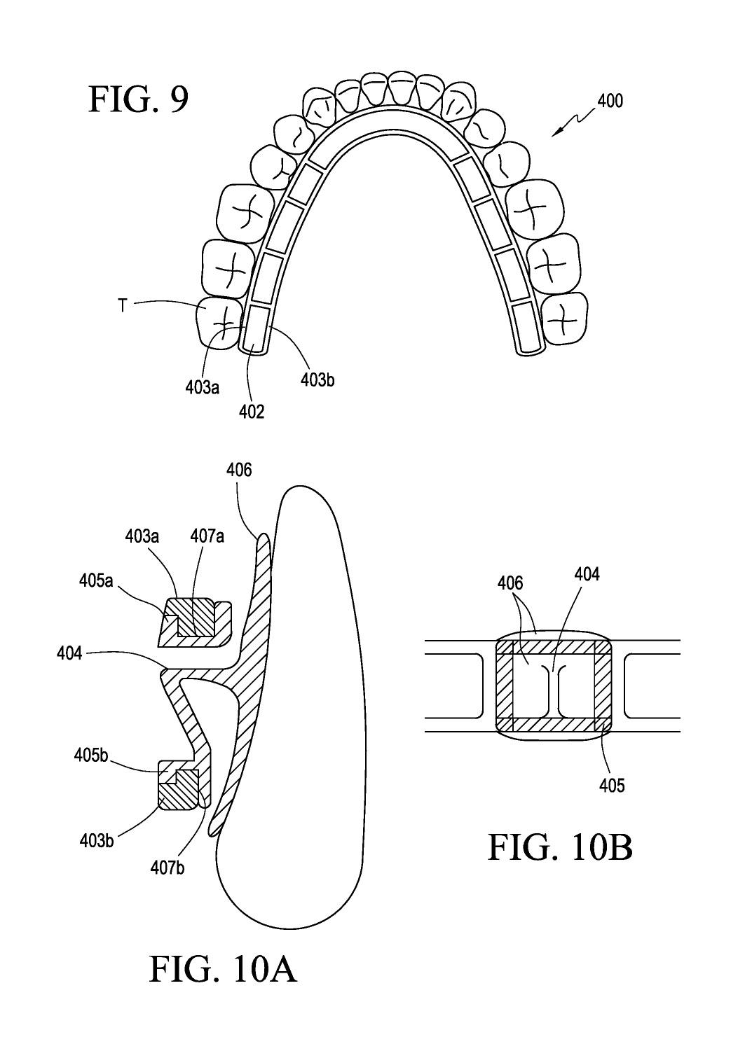

In another embodiment shown in FIG. 9, the orthodontic assembly 400 may include a frame member 402 having a U-shaped track configuration for clip on components or for facilitating slidable movement of components along the frame member 402. As illustrated, the frame member 402 may include a track-like configuration including one or more rails 403a, 403b configured to receivably permit one or more clip members 404 and/or other interchangeable components to clip or slide along the frame member 402. As such, the clip member 404 exerts a force on one or more teeth T

As illustrated in FIG. 10A-10B the clip members 404 may include connecting features or lips 405a, 405b, which are configured for a clip or snap engagement with the respective rails 403a and 403b of the frame member 402. The frame member 402 permits the clip members 404 to slide or clip along the frame member 402 for selective engagement with one or more of the desired teeth T The connecting features 405a and 405b each include respective openings or grooves 307a, 307b for receiving the respective rails 403a, 403b therein.

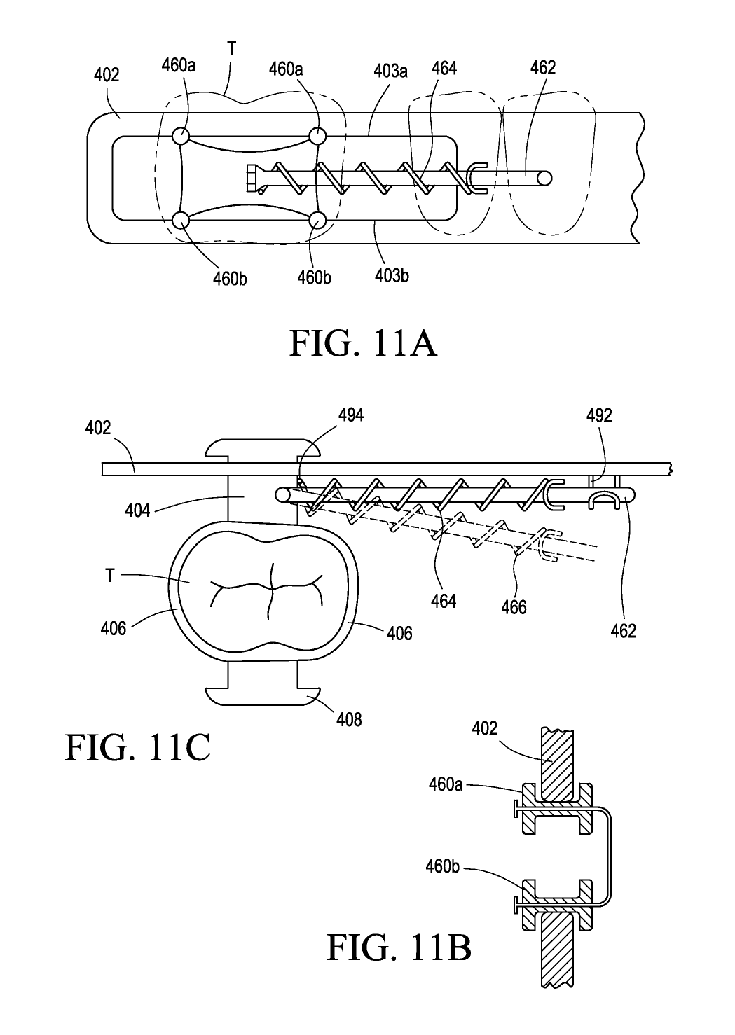

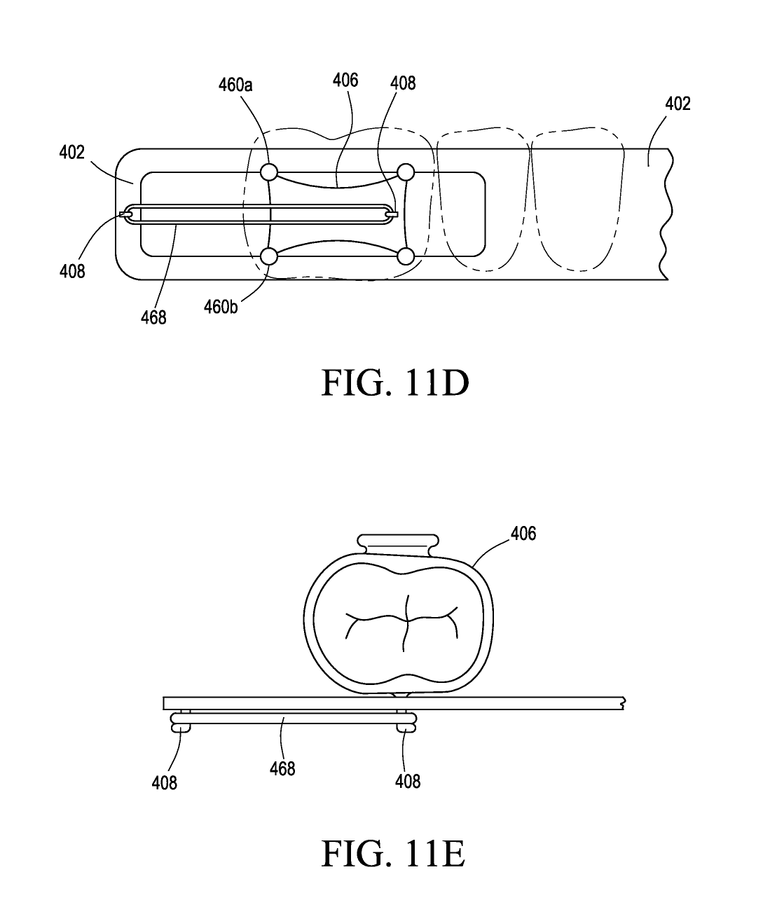

As illustrated in an embodiment shown in FIGS. 11A-11E, the orthodontic assembly provides a frame member 402 and a slidable clip member 404 configured to engage the user's tooth T. The clip member 404 may include one or more slides, or wheels 460a, 460b that permit the clip member 404 to slide along the frame member 402 and respective rails 403a, 403b. The clip member 404 may further include a sleeve member 406 which is configured to engage the buccal and lingual portions of the tooth. Engage the tooth like a ring or band around the tooth.

As depicted in FIG. 11A, the frame member 402 may be provided in the posterior area of the mouth to distalize the molar. The frame member 402 is operatively connected to a clip member 404 which includes a part member 408 to help in the seating of the band member 406 around the tooth T.

The orthodontic assembly 400 may further include a spring or biasing member 464. The spring 464 may be pre-loaded such that when the orthodontic assembly 400 is positioned in the user's mouth, the spring 464 exerts a force on the operatively connected clip member 404 and connected tooth T, thereby facilitating tooth movement or retention.

As illustrated, the orthodontic assembly 400 may further include a rod member 462. The rod member 462, which may be connected to the frame member 402 and extends along the rails 403a, 403b to provide guidance and support as the clip member 404 slides along the frame member 402. The biasing member 408 and band member 406, which encloses the tooth T, is capable of sliding along frame member 402 and through locking engagement 492. Rod member 462 may be rotated about a hinge member 494 provided on one side of the clip member 404 into locking engagement with a hook 492 on the frame member 402 on the other side.

The rod member 462 hinged engagement with hook 494 allows the spring 464 to be removed, activated, or replaced as needed. As illustrated in FIGS. 11D-E, elastic rubber bands 468 may also be connected to a catch members 408 on the band member 406 of the clip member 404, and to the outer surface of the frame member 402 and exert a biasing force on the tooth T.

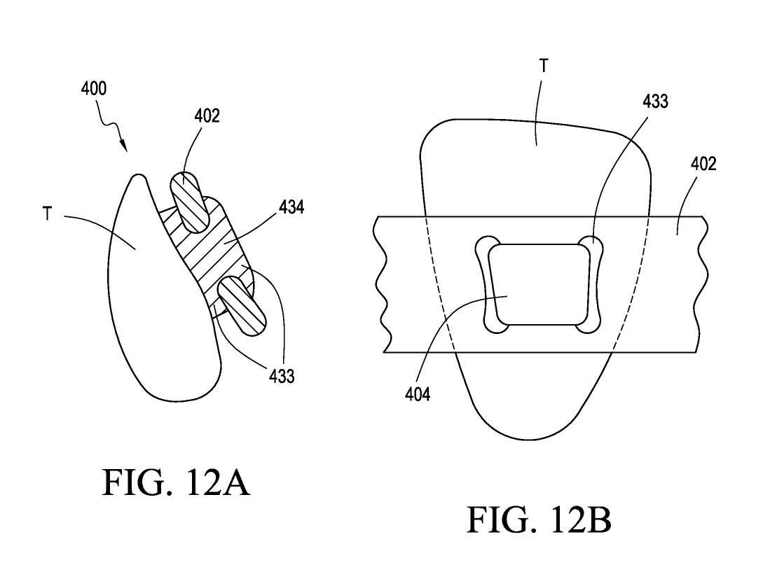

In an embodiment of the orthodontic assembly 400 illustrated in FIGS. 12A and 12B, the clip member 434 is connectable to the track frame member 402 to exert a force on an engaged tooth T. The clip member 434 may include a generally elastic module 433. Notably, the clip member 434 may be provided with the elastic member, wherein the elastic module inserted into the frame member 402 and pre-loaded to exert a biasing force on tooth T or group of teeth when in an engaged position. The force applied to the tooth T may be controlled by modifying the size of the clip member 434 and elastic module 433, or by adjusting the distance between the frame member 402 and the tooth T.

The clip member 434 may be operatively connected to one or more hooks, windows or grooves (not shown) provided in the frame member 402. As such, when the orthodontic assembly is positioned in the user's mouth, and the clip member 434 is seated in the frame member 402, the elastic module 433 may be compressed or stretched, thereby selectively exerting a force on the engaged tooth T or teeth. Notably, the clip member 434 and elastic module 433 may be configured as one joined component.

The elastic clip member 434 may be interchanged with a clip member 434 having a different shape or biasing force to force the tooth to move in the desired direction. Notably, it is contemplated that clip member 434 may be manufactured in customizable size, shapes, and colors, including a clear color, using 3-D printing and any other manufacturing processes. It is further contemplated the clip member 434 may be used in the anterior portion of the mouth and attached to a fastening member such as a hook, which is described below herein.

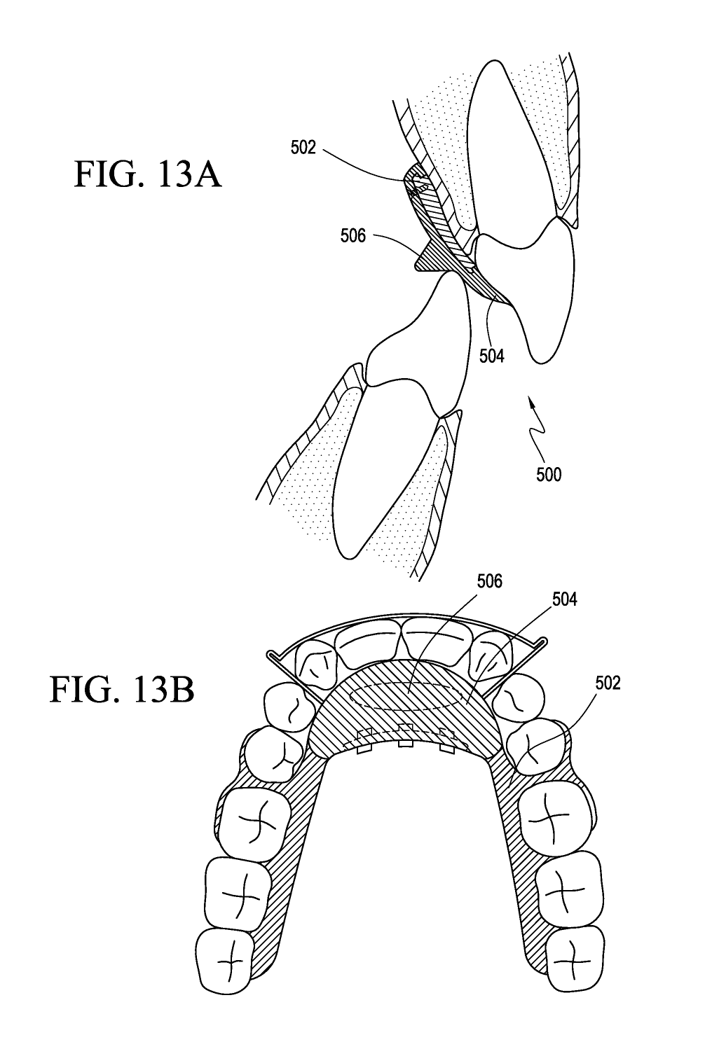

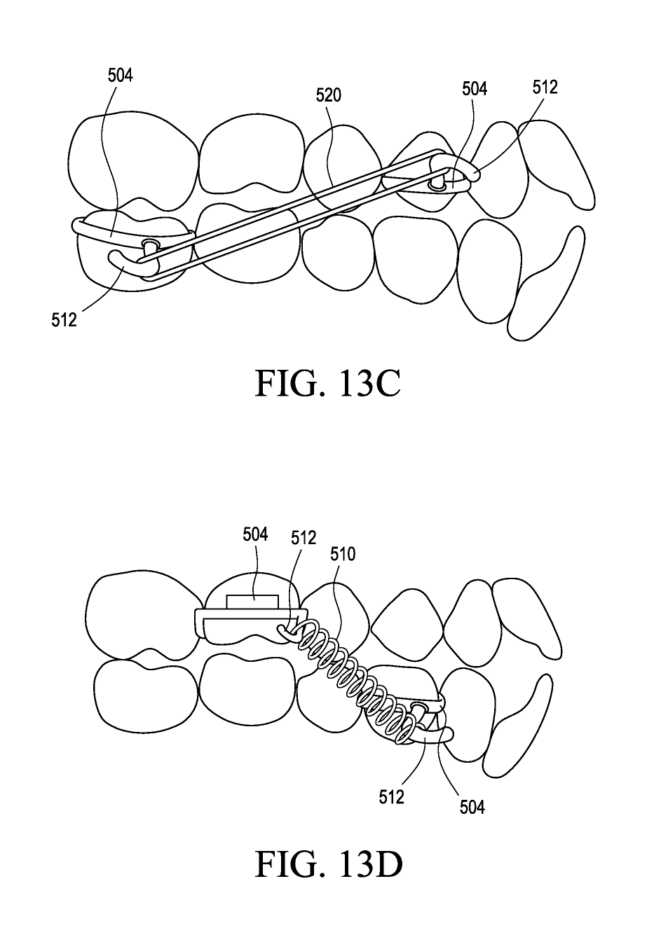

In an embodiment illustrated in FIGS. 13A and 13B, the orthodontic assembly 500 may further include a frame member 502 including clip members 504 to facilitate “bite correction.” Notably, different clip members having different components may also be used for habit modification. As shown, the clip member 504 may include one or more angled or ramp portions 506. The ramp or inclined portion 506 may be positioned for engagement with a portion of the lower teeth to facilitate bite correction. It is contemplated that multiple clip members 504 may be provided with different positions of the ramp on the clip for the purposes of forward positioning of the lower jaw in addition to opening the bite. Forward positioning is when the lower jaw and teeth are forced into a position that is a more forward position than the natural closing position over a period of time until the new jaw position becomes permanent.

FIG. 13B is an occlusal top view of the upper palate illustrating the orthodontic assembly 500 and clip member 504 of FIG. 13A positioned in the frame 502.

FIG. 13C is a lateral, side view of a hook component 512 originating from a frame member 502 or clip member 504 on the frame (not shown) of the upper and lower arches and connected with elastic rubber bands 520 for bite correction. FIG. 13D is a lateral, side view of components originating from a frame member 502 (not shown) or clip member 504 on the frame member of the upper and lower arches and connected with a spring 510 for bite correction.

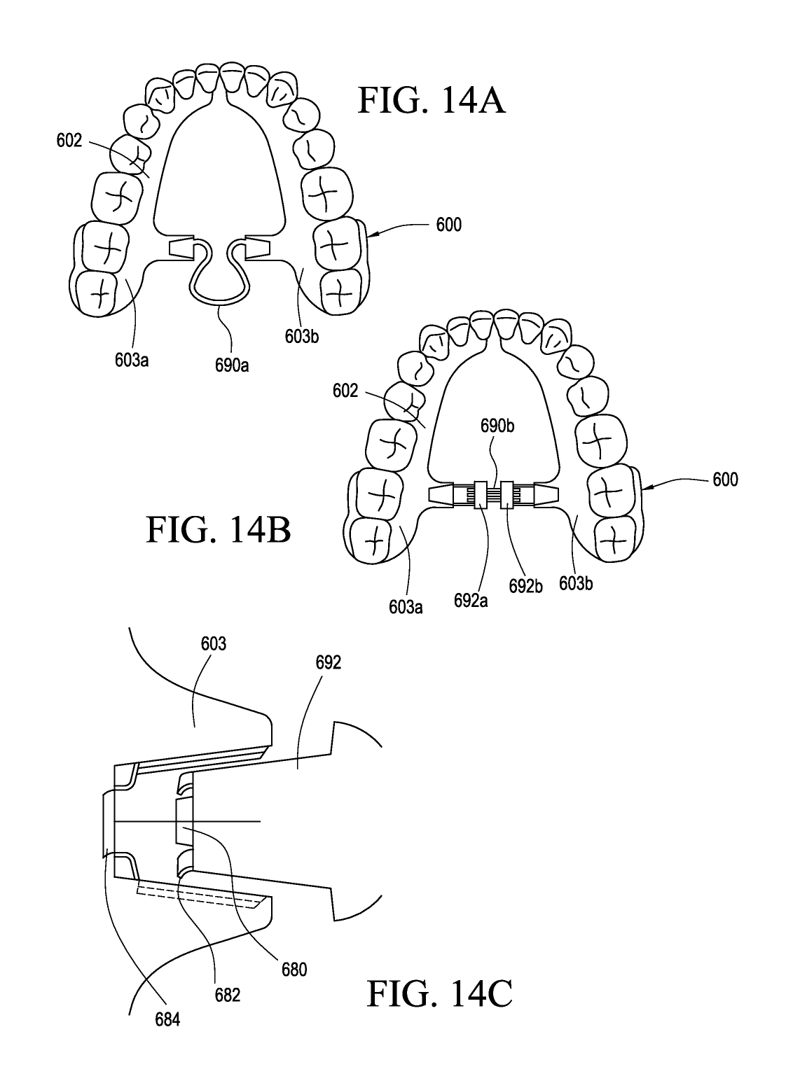

In another embodiment illustrated in FIGS. 14A and 14B, the orthodontic assembly 600 may be configured to facilitate widening of the arches of a user's teeth. The orthodontic assembly 600 includes a frame assembly 602 of two portions 603a and 603b and an adjustment member 690. The frame assembly 602 and adjustment member 690 may be configured and manufactured via the aforementioned 3-D printing methods. As such, the frame assembly 602 is configured and manufactured to conform to the middle of the upper portion and/or lower portion of the user's mouth to facilitate widening of the arches. As illustrated, the frame assembly 602 may include a first portion 603a and a second portion 603b configured to receive a dual clip member active component 690 for the expansion of the palate of the user's mouth. In one embodiment, arch widening may be achieved by inserting the assembly with the dual clip adjustment member 690 into the user's mouth, and providing after a predetermined time a replacement of the dual clip adjustment member 690 incrementally increasing the force on the teeth forcing them apart.

The adjustment component 690 may be but not limited to, a rotating active component 690b called hyrax, commonly used in fixed appliances to expand the arch and the teeth in the mouth, FIG. 14 B, or a flexible U-shaped spring member 690a FIG. 14 A. The active member 690 is positioned intermediate to the first portion 603a and second portion 603b to apply a lateral biasing force or pulling force to each of the portions 603a, 603b. The adjustment component 690 may be adjusted, replaced or modified to vary the force exerted on the first and second portions 603a, 603b. As such, during the adjustment process, replacement of the adjustment member 690 to selectively increase the biasing or pulling forces of the adjustment member 690 on the portions 603a, 603b either forces the first portion and second portion 603a, 603b together to facilitate narrowing of the arches or pushes the first portion 603a and second portion 603b apart, thereby facilitating of the expansion of the user's arches. The dual clip adjustment member 690 may be removed after the expansion is accomplished and replaced by a simple bar to minimized discomfort associated with the size and shape to the active components.

As shown in FIG. 14C the clip member 692 is removably insertable into a portion of the adjustment member 603 of the frame assembly 602. The edge portion 680 is insertable into the aperture 684 formed in the adjustment member 603, and the clip portions 682 engage the inner edge of the aperture 684 thereby locking the clip members 692 to the adjustment member 603.

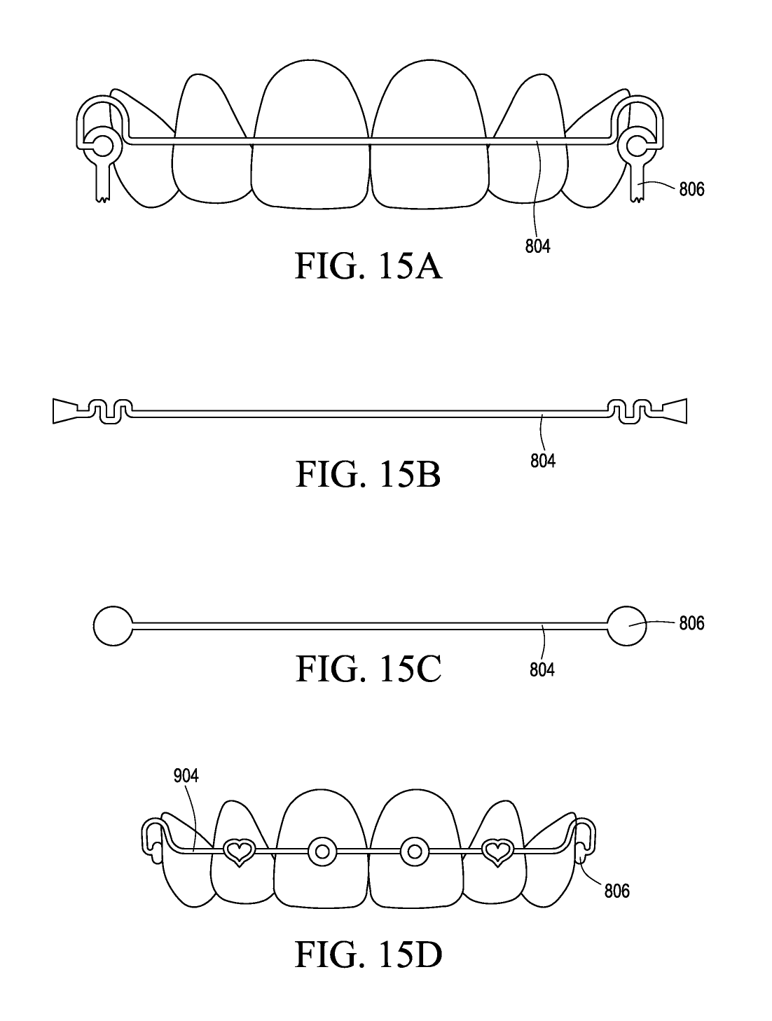

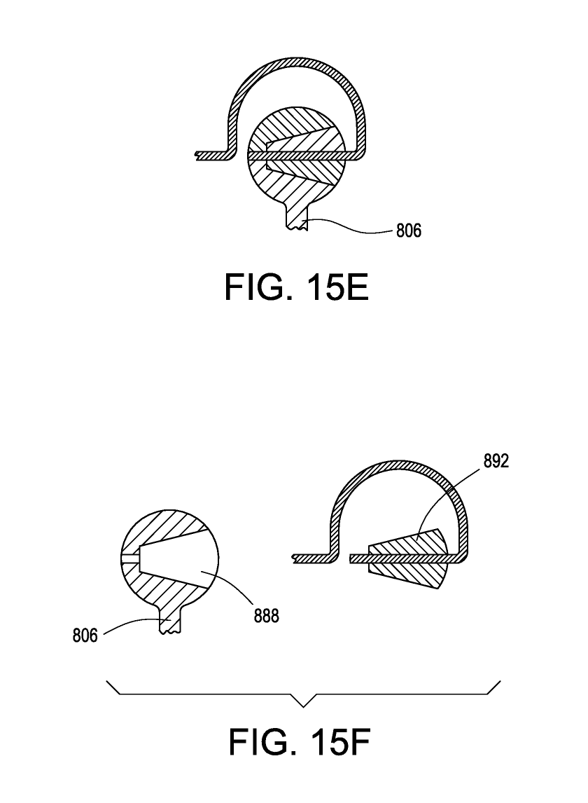

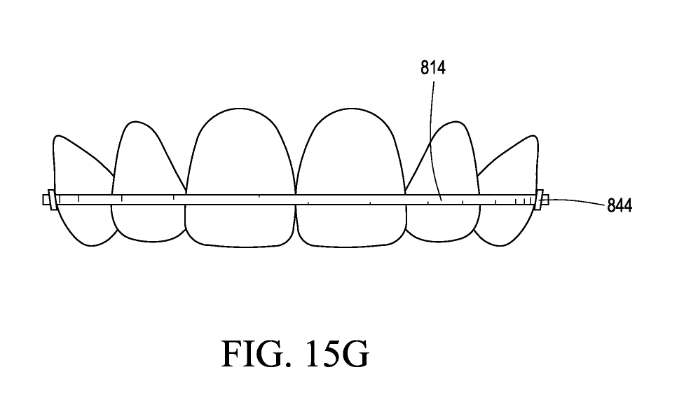

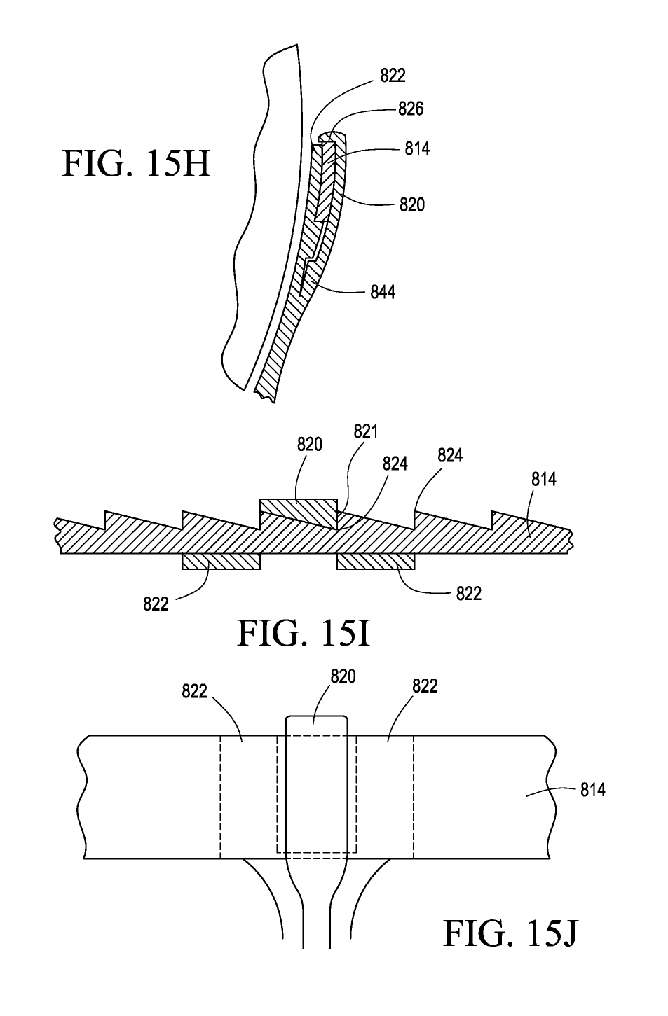

In an embodiment illustrated in FIGS. 15A-J, the orthodontic assembly 800 includes labial bow member 804, which is configurable for positioning in the anterior portion in the user's mouth and a component member 806. The labial bow member 804 is removably connected to the component member 806 to apply a force or rest passively on the user's teeth. The component member 806 may be connected to a frame member (not shown).

As illustrated, the labial bow member 804 exerts a force on the user's teeth to facilitate tooth movement or rest passively on the user's teeth and may include a variety of configurations. The labial bow 804 may include an assortment of configurations, which may include, but are not limited to, circles hearts and stars. Additionally aesthetic clips may be used in combination with a connected frame member. The labial bow member 804 is interchangeably replaceable such that a user or orthodontic professional may easily remove and/or replace the labial bow as desired. The labial bow member 804 may be inserted into an opening 888 formed in the component member 806.

The labial bow member 804 may also include a fastening member 892 having a wedge-shaped body. To facilitate the interchange of labial bow members 804, the orthodontic assembly 800 further includes a component member 806 having an aperture 888 formed therein configured to receive the fastening member 892 therein. As illustrated, the fastening member 892 is inserted into the aperture 888 securing the bow member 804 to the hook member 806. Notably, the labial bow configuration permits a user to easily interchange or adjust the labial bow members 804 with a different labial bow member 804 having different shapes, designs, materials or biasing force on the teeth T.

Further, the labial bow embodiment permits the insertion of elastomeric string FIG. 15 C which is flexible and may be stretched permitting the ball shaped endings to be inserted into the respective fastening members 888.

The component locking member 806 may receive an either semi-rigid or elastomeric labial bow member therein, for added flexibility and for visually aesthetic purposes. Notably the loop originating from 892 of semi-rigid configuration may be flexed to facilitate the insertion of the labial bow into the opening 888.

As illustrated in FIG. 15G, the labial bow may include a clear strip member 814 that is provided about the outside portion of the teeth to achieve tooth retention and or movement. The clear serrated strip member 814 slides into a locking clip member 844 that is attached to the frame 802 or clip member 804 provided on a frame member 802. The length of the clear strip member 814 may be adjusted using a cable and tie feature.

As illustrated in FIG. 15H of the orthodontic assembly of FIG. 15G includes the labial strip member 814, a clip member 844 configured to receive the labial member 814 therein. The clip member 844 includes an inner clip portion 822 and an outer clip portion 820 configured to receive a portion of the labial member 814 therebetween. The outer clip portion 820 has a flexible body permitting the outer clip portion 820 to flex when the labial member 814 is slidably adjusted, thereby permitting the labial member to slide therein.

As illustrated in FIG. 15I, the outer lip portion 820 includes a locking portion 821, which engages a corresponding inner edge 824 of the labial bow member 814, locking the strip member in a selected position. The clip portion 820 also includes a top edge member 826 which controls movement of the labial member 814. As illustrated, FIG. 15I is a top sectional view of the orthodontic assembly of 15G, illustrating the labial bow member and the clip member connection. FIG. 15J is a frontal view of the orthodontic assembly of 15G, illustrating the labial bow member 814 and clip member 804 relationship. Labial member 814 could be either simple clear serrated strip or could be customized and 3D printed to fit the individual teeth of the user.

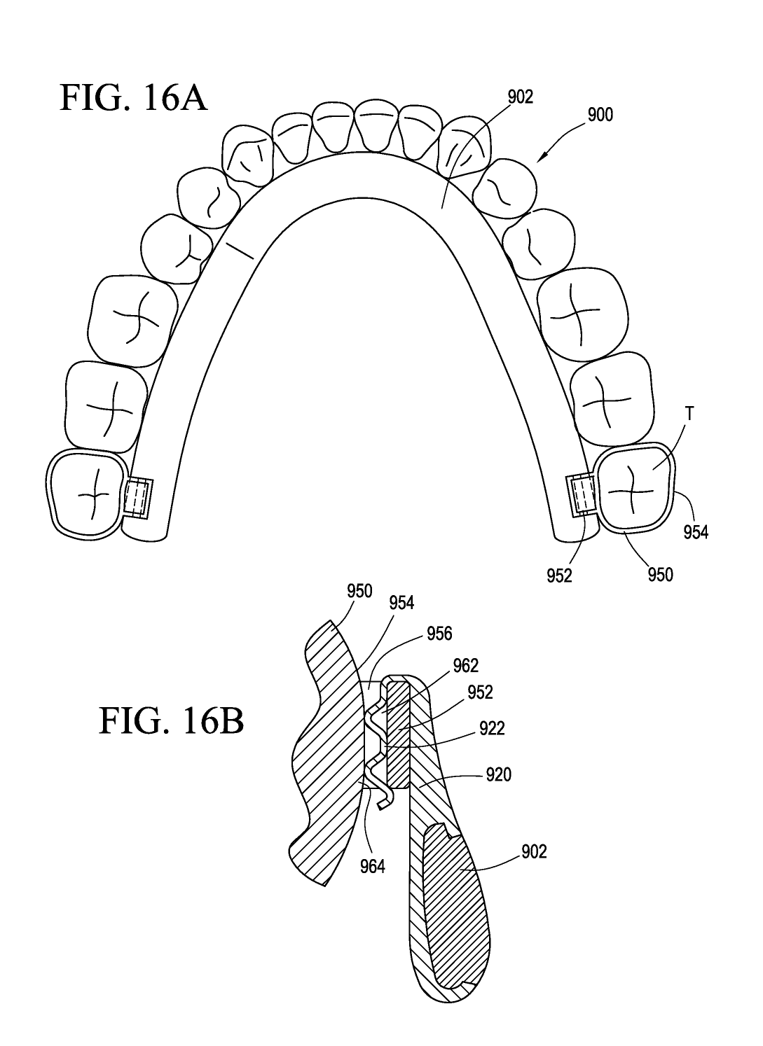

In an embodiment of the orthodontic assembly 900 illustrated in FIGS. 16A-B, the orthodontic assembly 900 generally includes an arcuate U-shaped frame member 902 which via 3-D printing is adaptable to be conformed for positioning about the lingual portion of the user's teeth T. The orthodontic assembly 900 further includes a tooth band assembly 950 configured to receivably encompass a selected tooth or series of teeth, and an extension from the clip member 904 or frame member 902 configured for securing the frame member 902 to the tooth band assembly 950.

As illustrated in FIG. 16A, the tooth band assembly 950 generally include a band member 954 which is adapted to receive the user's tooth therein. A lip member 952 extends generally outward from the band member 954. An opening 956 is formed between the band member 954 and lip member 952, and is configured to receive a portion of the clip member 904 or frame member 902 therein. As illustrated, the clip member 904 is removably connectable to both the frame member 902 and the tooth band assembly 950, and as such, fastens the frame member 902 to the tooth band assembly 950.

As illustrated in FIG. 16B, the clip member 904 extends from the frame member 902 in a generally upward direction. The clip member 904 includes a base portion 920 which is connected to the frame member 902 and a head portion 922 having a zigzag or sinusoidal wave-like configuration which may simultaneously engages the inner surface 962 of the lip member 952 and the outer surface 964 of the tooth band member 954 to provide a secure connection thereto.

As illustrated, multiple band assemblies 950 may be provided to engage multiple teeth and multiple locations in the mouth to provide multiple points of connections for the frame member. Further, as illustrated in previous embodiments, the clip members 904 may be removably connected to the frame members or integrally formed with the frame members. Band member assembly 950, frame member 902 and clip member 904 may all be manufactured via a variety of manufacturing techniques including but not limited to 3D printing.

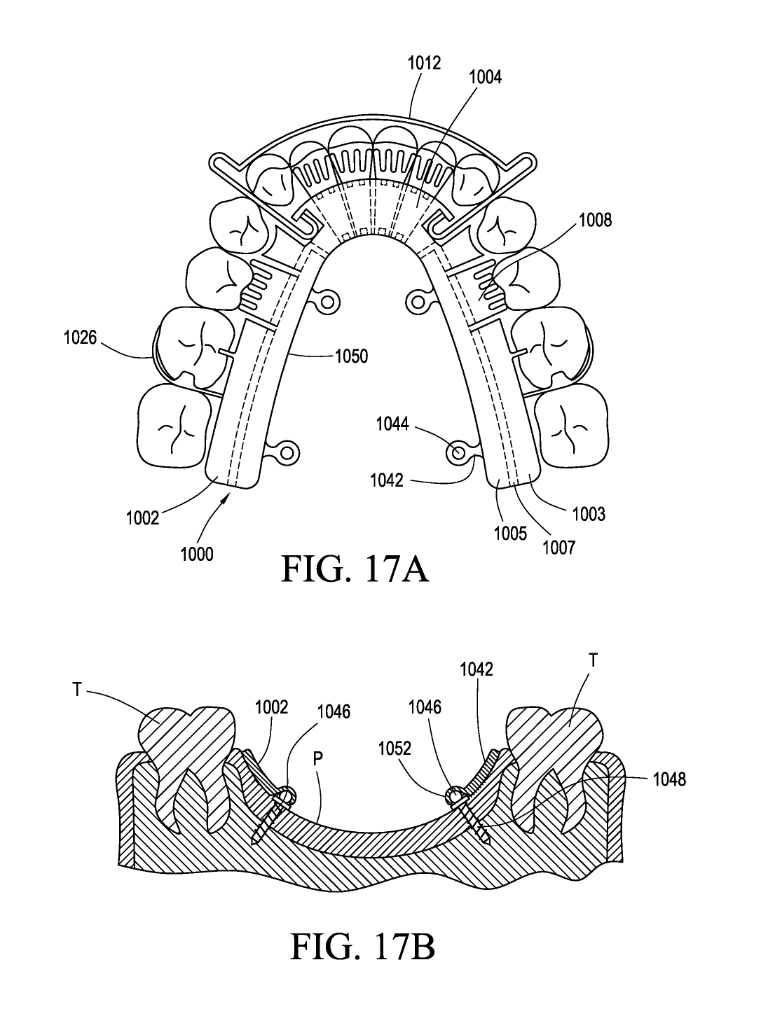

In an embodiment illustrated in FIGS. 17A and 17B, the orthodontic assembly 1000 includes a temporary anchorage device (“TAD”) frame assembly 1005, configured to be removably fastened to a palate portion P of the user's mouth using one or more fastening members 1046. Similar to the previously described frame member 202 illustrated in FIG. 1B, the frame assembly 1005 has a generally U-shaped arcuate configuration, which is adaptable via the 3D printing or any other manufacturing process be conformed to the interior lingual surface of the selected user's mouth.

The frame assembly 1005 includes intermediate flexible or semi flexible connector members 1007, Also similar to the aforementioned embodiments, the orthodontic assembly 1000 may include a variety of interchangeable components, including but not limited to, one or more retainer members 1012, one or more clip members 1004, one or more integrally formed active elements 1008, and one or more C-clasp members 1026

The frame assembly member 1005 having a lower frame portion 1050 may include one or more tab members 1042. The tab members 1042 may be positioned along the inner edge of the lower frame portion 1050 of the frame assembly 1005 and as such, extends in a generally inward direction from the inner edge of the lower frame portion 1050. The tab member 1042 includes an opening 1044 configured to receive the fastening member 1046 therethrough such that the secure the assembly 1000 in the mouth.

As illustrated in FIG. 17B, each TAD (temporary anchorage device) fastening member 1046 generally includes a shaft portion 1048 secured in the palatal bone and head portion 1052 for securely fastening the member 1042 of the frame assembly 1005 to TAD. It is contemplated that the frame assembly 1005 may include a plurality of tab members 1042, thus permitting the orthodontic assembly 1000 to be securely fastened to the palate of the user's mouth at multiple locations.

Though the various embodiments have been described in detail with particular reference to certain aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

1. An orthodontic assembly to be used in a user's mouth, comprising:
a frame member configured to be removably positioned proximate the lingual portion of the user's teeth including a fastening member; and
an interchangeable clip member configured to be removably affixed to the frame member such that the clip member engages at least one of the user's teeth,
wherein the fastening member is configured to cooperatively engage the clip member such that the clip member may be removably affixed to the frame member.

2. The orthodontic assembly of claim 1, wherein the frame member has a rigid portion configured to engage an inner portion of the user's mouth and a portion configured to engage at least one of the user's teeth.

3. The orthodontic assembly of claim 1, wherein the frame member includes a first rigid portion, a second portion, and a flexible intermediate portion provided intermediate to the first rigid portion and the second portion to provide flexibility to the frame member.

4. The orthodontic assembly of claim 3, wherein the intermediate portion has a flexible c-shaped cross-section configured to provide flexibility to the frame member.

5. The orthodontic assembly of claim 1, wherein the frame member includes a rigid portion having a first track member and a second track member in spaced relation to each other, wherein the first track member and second track member each extend along an inner portion of the user's mouth and are cooperatively configured to operatively engage one or more clip members.

6. The orthodontic assembly of claim 1, wherein the frame member includes a first portion configured to engage a first lingual portion of the user's teeth, a second portion configured to engage a second lingual portion of the users' teeth and an adjustment member provided intermediate to the first and second portion to apply a force intermediate to the first and second portion to facilitate expanding the palate.

7. The orthodontic assembly of claim 1, wherein the frame member includes one or more tab members that extend from an inner portion of the frame member, permitting the frame member to be removably fastened to fixed screws inserted in the user's mouth.

8. The orthodontic assembly of claim 1, wherein the clip member includes a first portion configured to engage the frame member and a second portion configured to engage one or more of the user's teeth.

9. The orthodontic assembly of claim 1, wherein the clip member includes a first portion configured to operatively engage the frame member and a second flexible portion configured to operatively engage the tooth to facilitate tooth movement.

10. The orthodontic assembly of claim 1, wherein the clip member includes a retentive member configured to engage a portion of one or more of the user's teeth.

11. The orthodontic assembly of claim 1, wherein the clip member includes a first portion configured to engage a lingual portion of the user's tooth and a second portion configured to engage a buccal portion of the user's tooth.

12. The orthodontic assembly of claim 1, wherein the clip member includes a governing portion that cooperatively engages a lingual portion and an occlusal portion of the user's tooth to facilitate bite correction and tooth movement.

13. The orthodontic assembly of claim 1, wherein a first clip member includes a fastening portion that removably cooperatively connects to the frame member, a second clip member, and a governing portion that extends over an occlusal surface to an buccal surface of the user's tooth to facilitate bite correction and tooth movement.

14. The orthodontic assembly of claim 1, further including a bonded member fastened to at least one tooth, the bonded member configured to cooperatively engage the clip member such that the clip member and connected frame member may be removably affixed to the bonded member. so as to facilitate tooth movement and retention

15. The orthodontic assembly of claim 1, wherein the clip member is operatively connected to the frame member and engages two or more teeth to facilitate tooth movement or retention.

16. The orthodontic assembly of claim 1, wherein the clip member has an engagement portion which includes a first vertical flexible wavelike member and a second flexible vertical wavelike members joined in a middle section to facilitate tooth movement

17. The orthodontic assembly of claim 1, wherein the clip member has a flexible engagement portion that includes a plurality of flexible extension members and bristles that extend from the clip to engage and facilitate tooth movement.

18. The orthodontic assembly of claim 1, further including a labial bow member that extends along an outer portion of the users' teeth and configured to operatively engage a first clip member connected to a first side of the orthodontic assembly and a second clip member connected to an opposing second side of the orthodontic assembly.

19. The orthodontic assembly of claim 1 wherein the orthodontic assembly includes at least two clip members, each including an outer lip portion including a locking portion configured to receivably engage a corresponding inner edge of a labial bow member.

20. The orthodontic assembly of claim 1, wherein the clip member is removably fastenable to an outer portion of the frame member.

21. The orthodontic assembly of claim 5, wherein the clip member is removably fastenable to an inner portion of the first track member and second track member of the frame member.

22. The orthodontic assembly of claim 1, further including a band member configured to receive a tooth member therein, the band member configured to cooperatively engage the clip member, such that the clip member and a connected frame member may be removably affixed to the band member, so as to facilitate tooth movement and retention.

23. The orthodontic assembly of claim 1, wherein the frame member is positioned proximate to the palatal portion of the user's teeth and the clip member fastenably engages a receiving portion of the frame member and includes a ramp portion configured to engage the opposing teeth in the mouth to facilitate bite correction.

24. The orthodontic assembly of claim 5 wherein the clip member includes an elastomeric pre-loaded biasing member configured to operatively engage at least one tooth to effectuate tooth movement.

25. The orthodontic assembly of claim 6, wherein the adjustment member is a clip with a flexible biasing member configured to exert a force on the first portion and second portion of the frame member so as to facilitate expanding the palate.

26. The orthodontic assembly of claim 1, wherein an upper assembly includes at least one clip member with a first hook extending in a first direction and a lower assembly includes at least one clip member with a second hook extending in an opposing second direction of the first hook, wherein the first hook and second hook are operatively connected with at least one biasing member so as to facilitate bite correction and tooth movement.

27. The orthodontic assembly of claim 1, wherein the clip member is provided intermediate to the frame member and user's tooth.

28. The orthodontic assembly of claim 1, wherein the frame member is manufactured using 3D printing such that the frame member conforms to the user's mouth to facilitate bite correction and tooth movement.

29. The orthodontic assembly of claim 1, wherein the clip member is manufactured using 3D printing such that the frame member and clip member when engaged, cooperatively provide a force on at least one of the selected teeth to facilitate bite correction and tooth movement.
